(19) United States
(12) Patent Application Publication
(10) Pub. No.: US 2008/0253133 A1
(43) Pub. Date: Oct. 16, 2008

(54) Reflectors for luminaires

(75) Inventors: Jose Antonio Laso, Newman, CA (US); Smita Anaoker, Smyrna, GA (US)

Correspondence Address: KING & SPALDING LLP, 1180 PEACHTREE STREET, ATLANTA, GA, 30309-3521, US

(73) Assignee: Cooper Technologies Company, Houston, TX (US)

(21) Appl. No.: 12/060,247

(22) Filed: Mar. 31, 2008

Related U.S. Application Data
(60) Provisional application No. 60/909,231, filed on Mar. 30, 2007.
(60) Provisional application No. 60/909,279, filed on Mar. 30, 2007.

(51) Int. Cl. F21V 7/00

(52) U.S. Cl. 362/341

(57) ABSTRACT

Reflectors for luminaires that are operative to reflect light provided by a lamp are described. The reflectors have a first side operative to reflect light and a second side operative to reflect light. The first side and the second side each include a number of steps. The first side and the second side form a substantially parabolic shape. The first side may be coupled to the second side via a flat portion that is configured to couple the reflector to a luminaire housing. The steps may comprise first steps and a second step, where the first step is coupled to the flat portion, and the second step is coupled to the first step. The second step may include a plurality of steps.

### CROSS REFERENCE TO ELATED APPLICATIONS

This patent application claims priority under 35 U.S.C. § 119 to U.S. Provisional Patent Application No. 60/909,231 entitled “Luminaire with Optics and Method of Mounting Thereof,” filed Mar. 30, 2007, and U.S. Provisional Patent Application No. 60/909,279, entitled “Luminaire with Optics and Method of Mounting Thereof,” filed Mar. 30, 2007. The complete disclosure of the above-identified priority application is hereby fully incorporated herein by reference.

### BACKGROUND

Fluorescent lamps are commonly used in various illumination applications. Fluorescent lamps generally provide similar light output to incandescent lamps with less power usage. However, because conventional fluorescent lamps are cylindrical, they emit light in all directions from the lamp. In most applications, this directs light away from the surface, object, or area that is to be illuminated, thus wasting energy. Furthermore, conventional fluorescent lamps are not capable of generating light of sufficient intensity for use in applications where the lamp is disposed a large distance from the area to be illuminated—for example—in warehouses with very high ceilings.

Accordingly, for many applications, the fluorescent lamp is installed within a luminaire that includes a reflector for focusing the light toward the surface, object, or area that is to be illuminated. The shape and reflective properties of the reflector dictate the ultimate light pattern that emanates from the luminaire. Furthermore, the shape of the reflector dictates how far apart luminaires can be placed (also known as the spacing criteria) while still providing optimal lighting on the surface, object, or area that is to be illuminated. Even a small increase in the spacing criteria of luminaires can significantly reduce the number of luminaires required to adequately illuminate a large structure, such as a warehouse or factory floor. Moreover, for certain applications—for example, the illumination of a workspace in a factory—more intensely focused light is required than is available from conventional reflectors.

Thus, a need exists in the art for reflectors that provide improved light distribution patterns for various applications.

### SUMMARY

The invention described in this application provides reflectors that can solve the above-described problems. In one aspect, the present invention provides a reflector for a luminaire that is operative to reflect light provided by a lamp. The reflector may have a first side that is operative to reflect light and a second side coupled to the first side operative to reflect light. The first side and the second side may comprise multiple steps. The reflector may be substantially parabolic in shape. The first side of the reflector may be coupled to the second side via a flat portion.

The reflector may have a first step and multiple second steps. The first step may be coupled to the flat portion, and the second steps may be coupled to the first step. The first step may form a first angle with the flat portion, and the multiple second steps may form a second angle where they couple to the first step. Each of the second steps may form the second angle where each second step is coupled to either the first step ore one of the second steps. The first angle may be substantially 172 degrees. The second angle may be substantially 175 degrees.

In another aspect of the invention, the steps may include a first step that forms a first angle with respect to the flat portion. The steps further may include a second step that forms a second angle with respect to the first step, a third step that forms a third angle with respect to the second step, a fourth step that forms a fourth angle with respect to the fourth step, and a fifth step that forms a fifth angle with respect to the fourth step.

In another aspect of the invention, a reflector for a luminaire operative to reflect light provided by a lamp is described. The reflector includes a first side operative to reflect light and a second side operative to reflect light. The first side and the second side are coupled to a flat portion that is operative to reflect light. The first side and the second side each comprise multiple steps. The interface between the first side and the top portion is substantially v-shaped, and the interface between the second side and the top portion is substantially v-shaped. Each of the steps spans a vertical distance and a horizontal distance.

In another aspect, the steps may include a first step, a second step, a third step, a fourth step, a fifth step, and a sixth step. In yet another aspect, the steps may include a first step, a second step, a third step, a fourth step, a fifth step, a sixth step, and a seventh step. In still another aspect, the steps may include a first step, a second step, a third step, a fourth step, a fifth step, a sixth step, a seventh step, and an eighth step. In another aspect, the steps result in a substantially curved reflector. BRIEF DESCRIPTION OF THE DRAWINGS

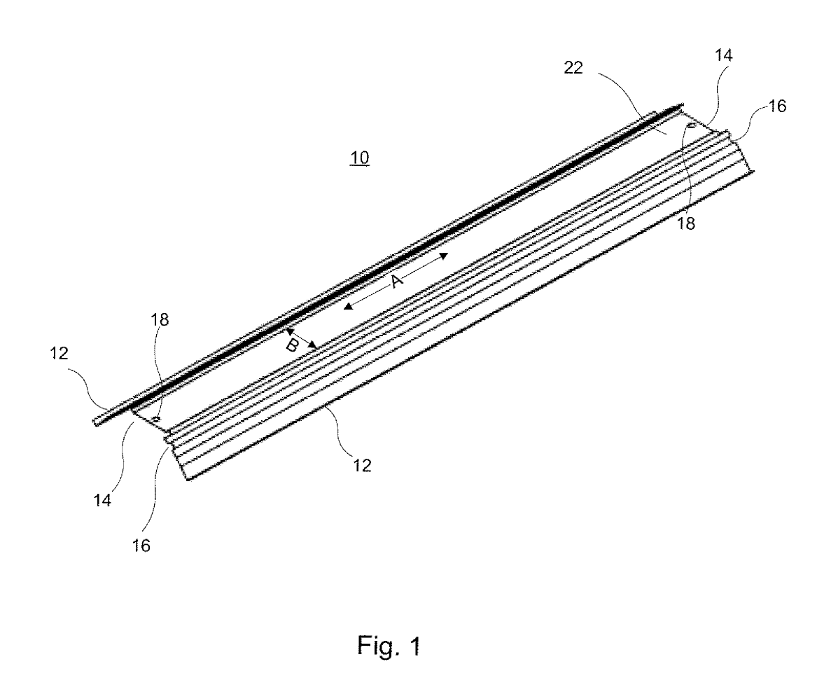

FIG. 1 is an illustration of an isometric view of a reflector for a luminaire according to an exemplary embodiment of the invention.

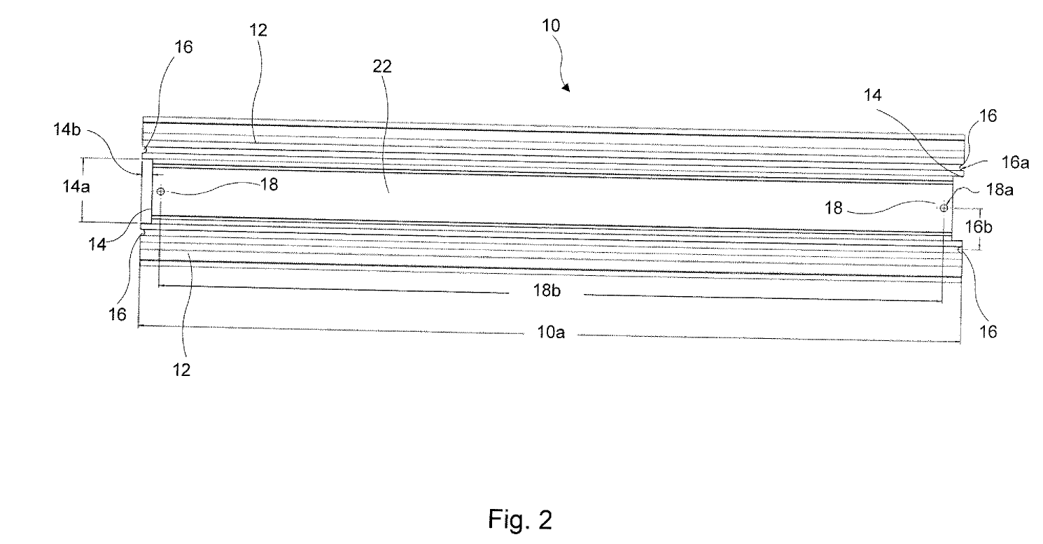

FIG. 2 is an illustration of a top view of the exemplary reflector of FIG. 1.

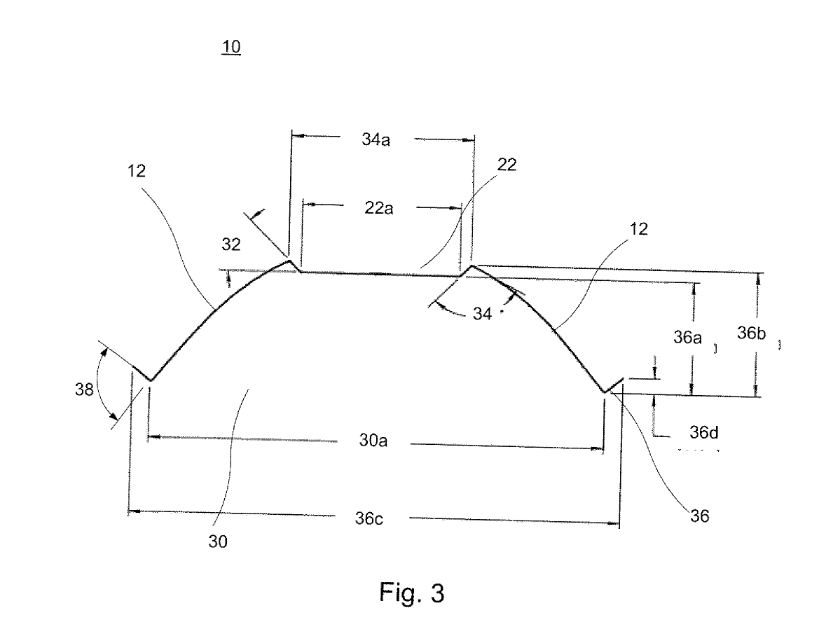

FIG. 3 is an illustration of a cross-sectional view of the exemplary reflector of FIG. 1.

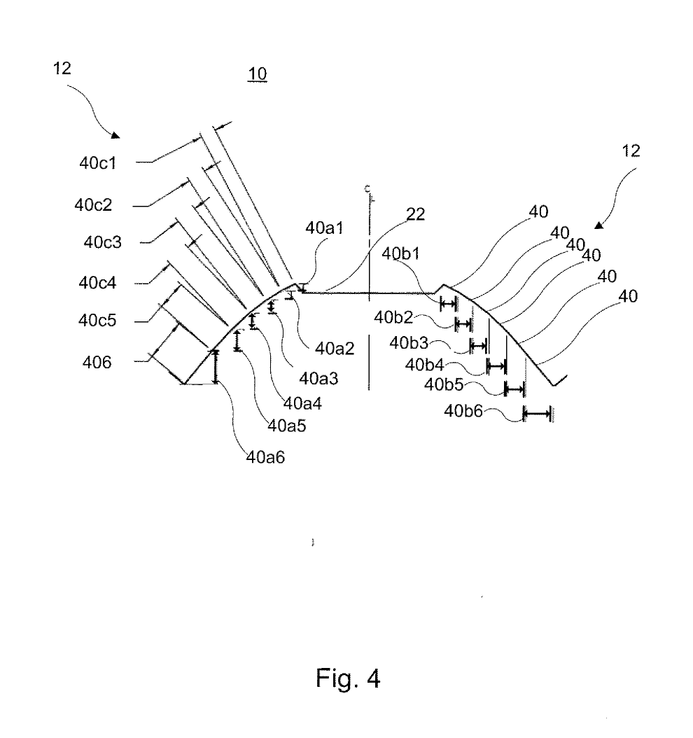

FIG. 4 is an illustration of another cross-sectional view of the exemplary reflector of FIG. 1.

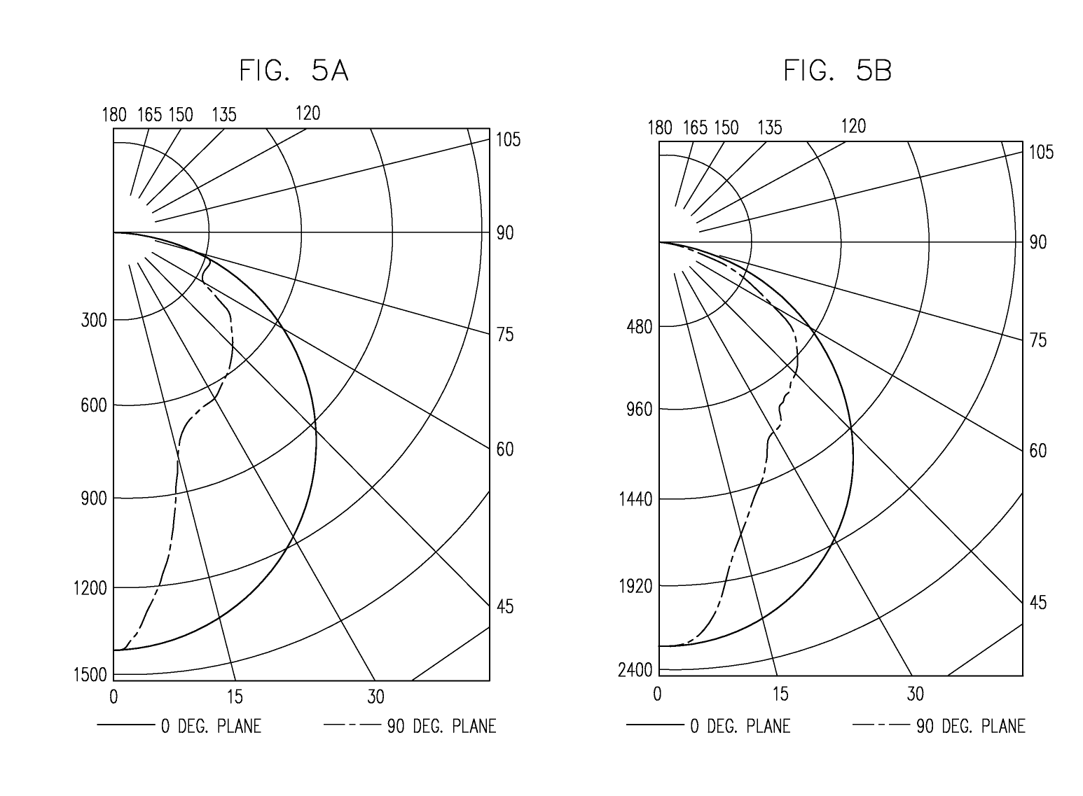

FIG. 5a is a zonal rumination plot for the exemplary reflector of FIG. 1 using a single 32 watt T8 linear fluorescent lamp rated at 2850 lumens.

FIG. 5b is a zonal lumination plot for the exemplary reflector of FIG. 1 using two 32 watt T8 linear fluorescent lamps rated at 2850 lumens.

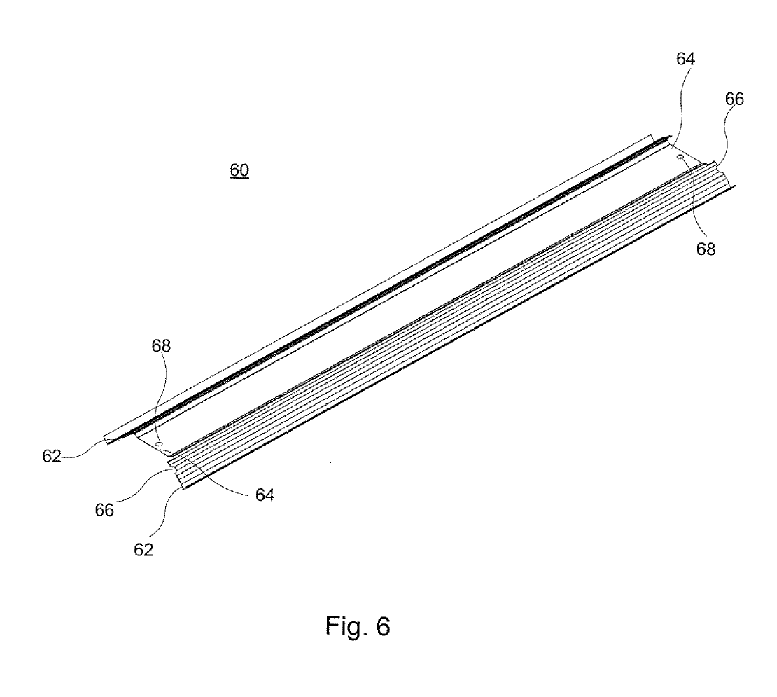

FIG. 6 is an illustration of an isometric view of a reflector for a luminaire according to another exemplary embodiment the invention.

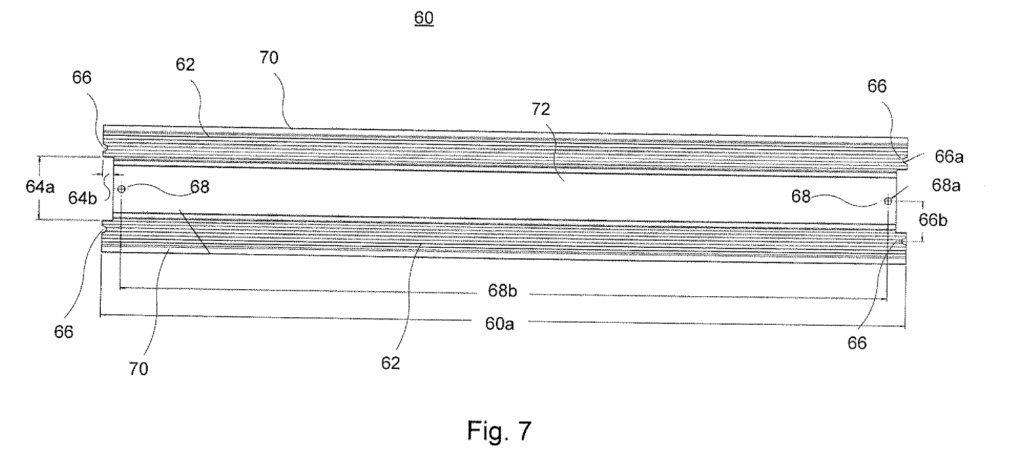

FIG. 7 is an illustration of a top view of the exemplary reflector of FIG. 6.

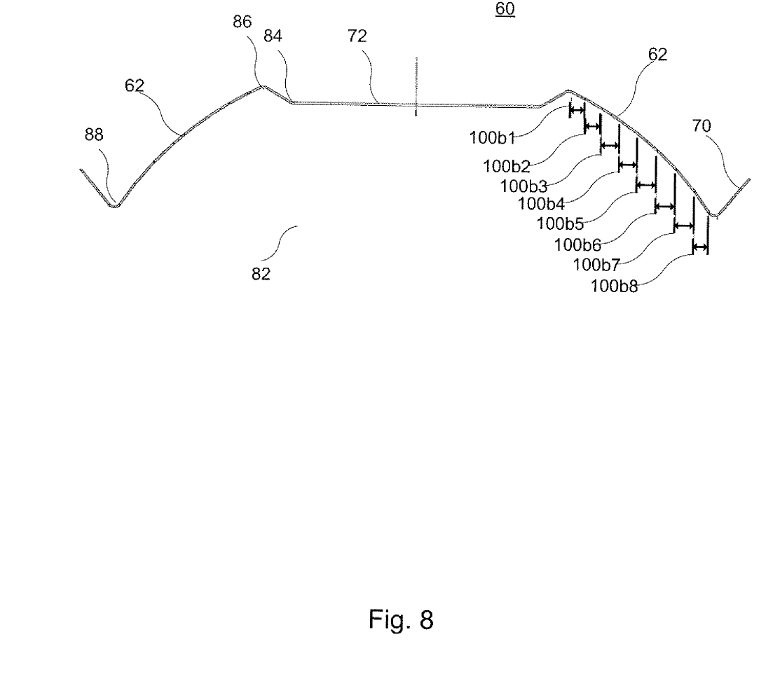

FIG. 8 is an illustration of a cross-sectional view of the exemplary reflector of FIG. 6.

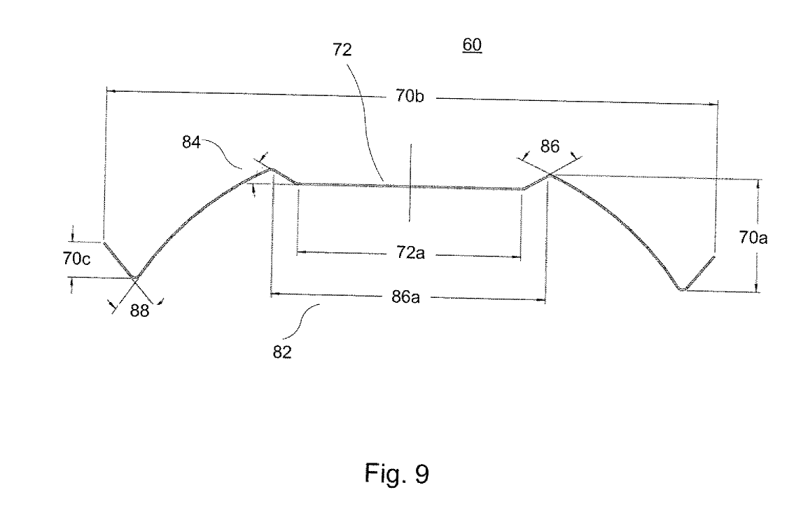

FIG. 9 is an illustration of another cross-sectional view of the exemplary reflector of FIG. 6.

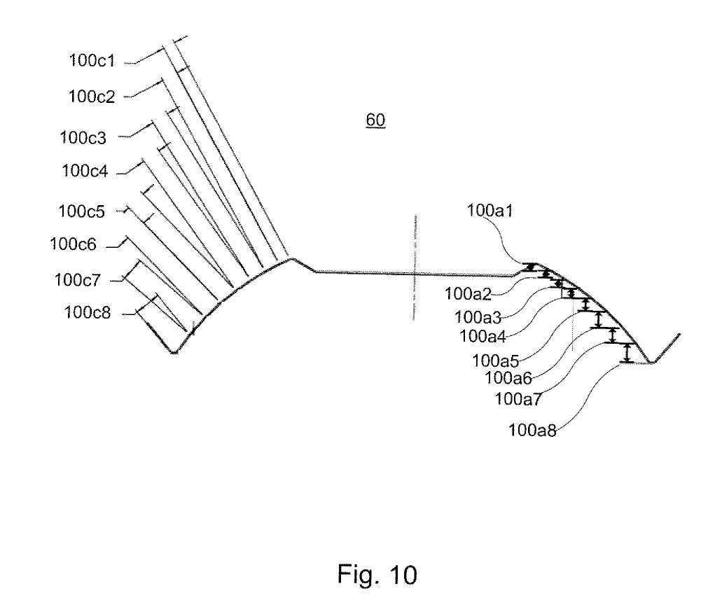

FIG. 10 is an illustration of another cross-sectional view of the exemplary reflector of FIG. 6.

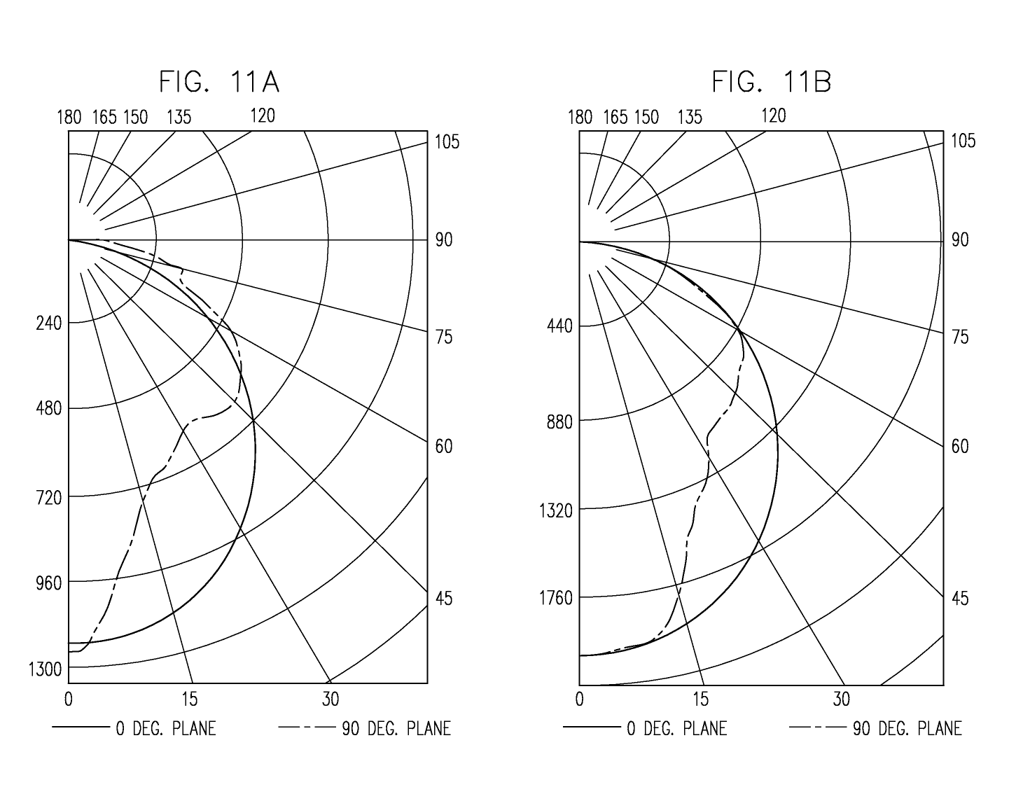

FIG. 11a is a zonal lumination plot for the exemplary reflector of FIG. 6 using a single 32 watt T8 linear fluorescent lamp rated at 2850 lumens.

FIG. 11b is a zonal lumination plot for the exemplary reflector of FIG. 6 using two 32 watt T8 linear fluorescent lamps rated at 2850 lumens.

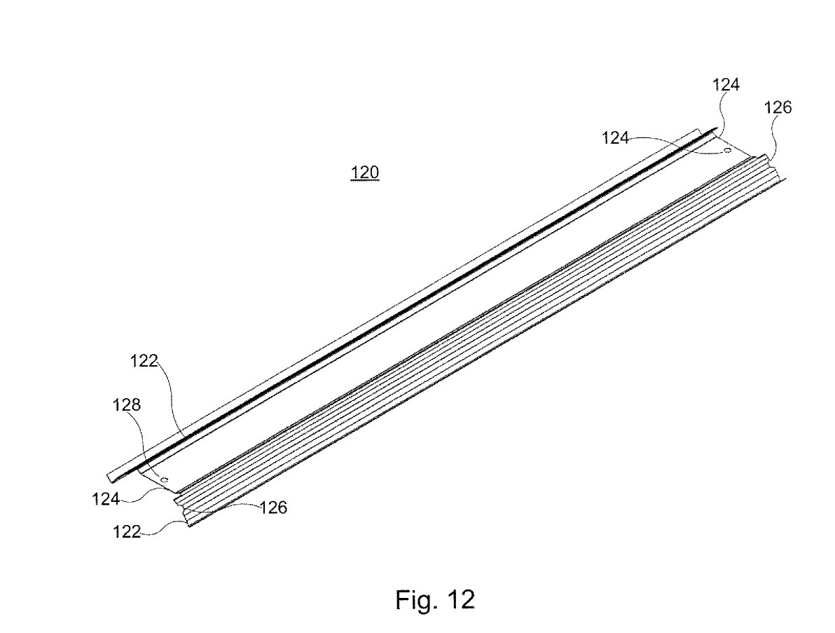

FIG. 12 is an illustration of an isometric view of a reflector for a luminaire according to another exemplary embodiment of the invention.

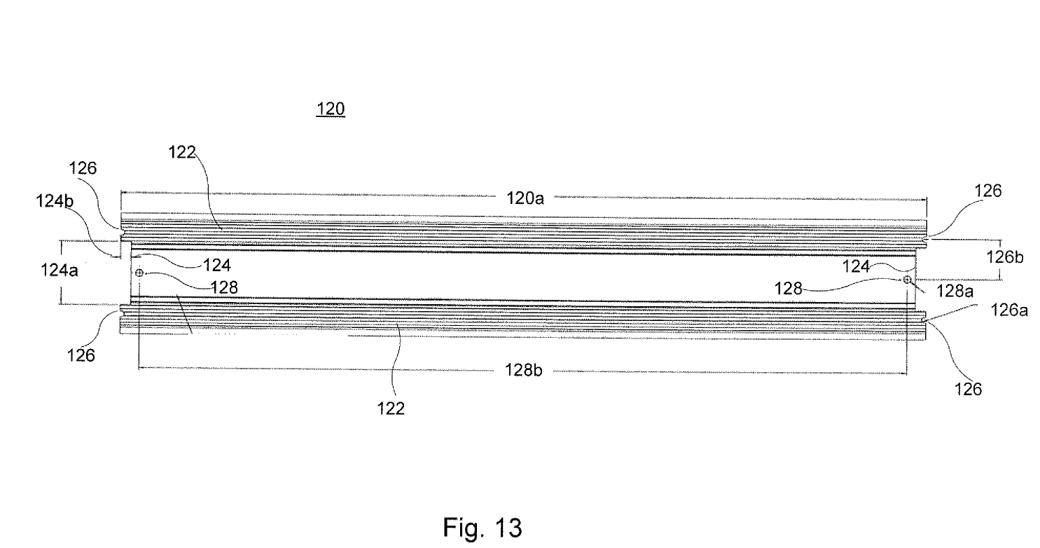

FIG. 13 is an illustration of a top view of the exemplary reflector of FIG. 12.

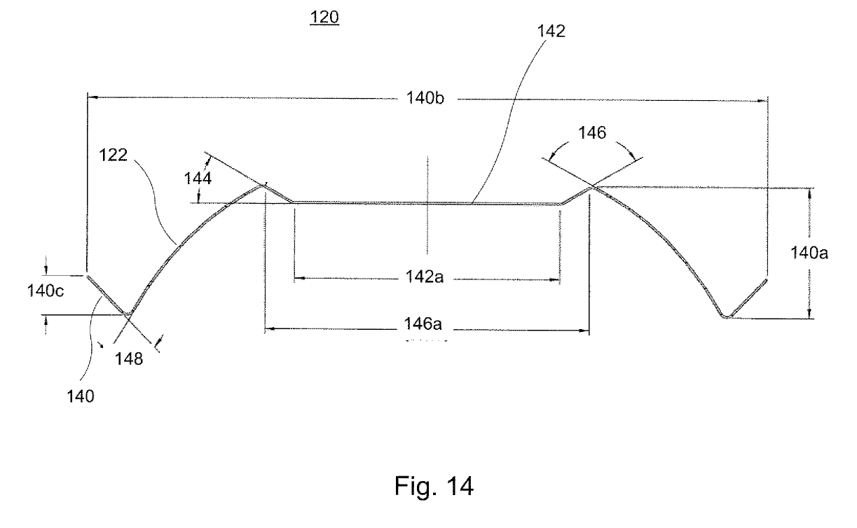

FIG. 14 is an illustration of a cross-sectional view of the exemplary reflector of FIG. 12.

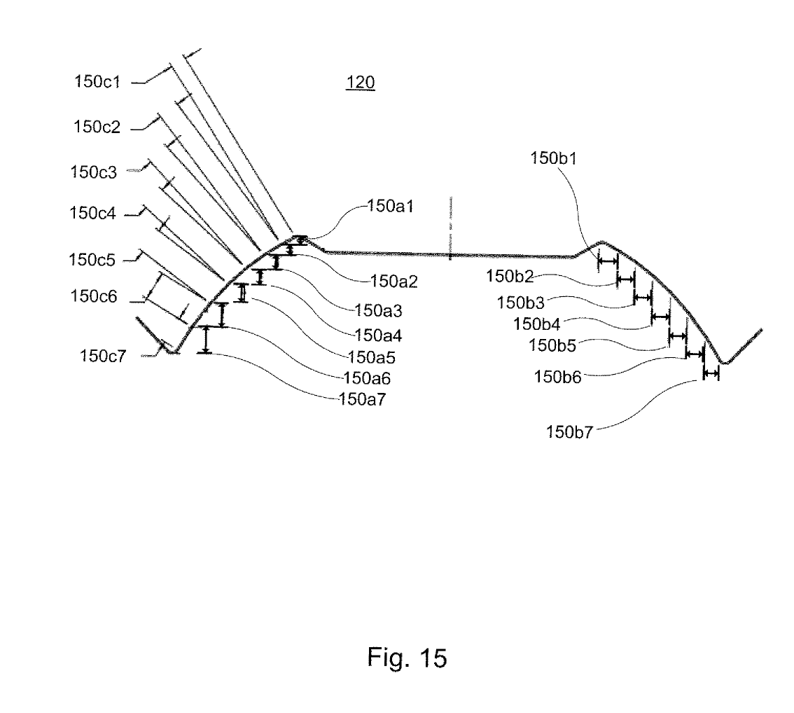

FIG. 15 is an illustration of another cross-sectional view of the exemplary reflector of FIG. 12.

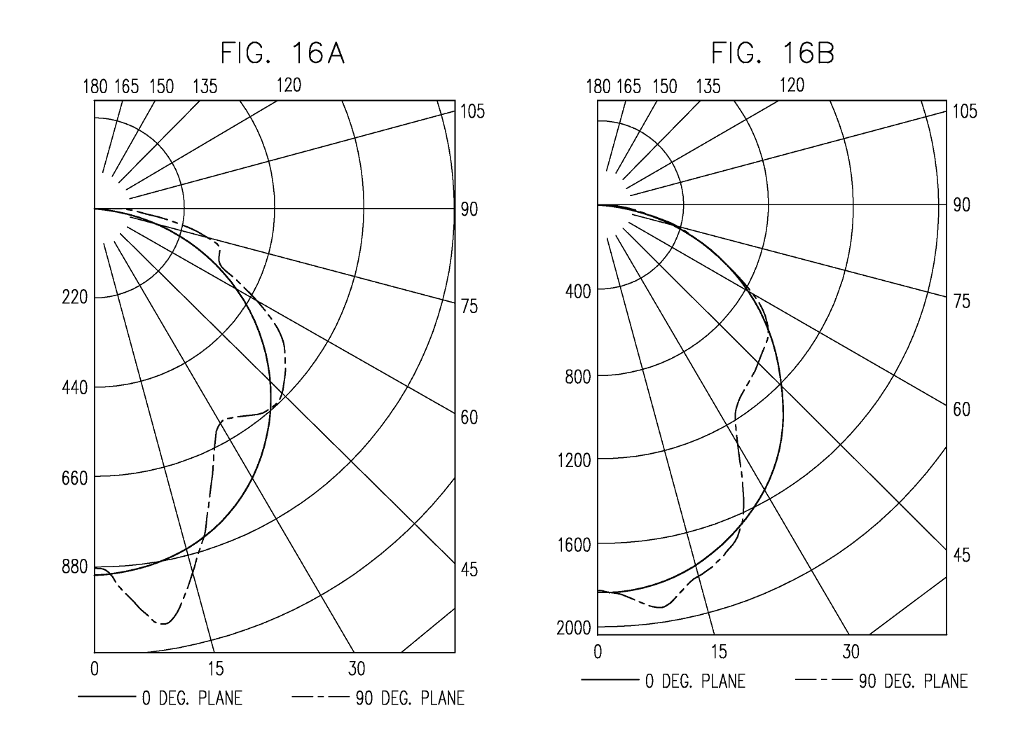

FIG. 16a is a zonal rumination plot for the exemplary reflector of FIG. 12 using a single 32 watt T8 linear fluorescent lamp rated at 2850 lumens.

FIG. 16b is a zonal rumination plot for the exemplary reflector of FIG. 12 using two 32 watt T8 linear fluorescent lamps rated at 2850 lumens,

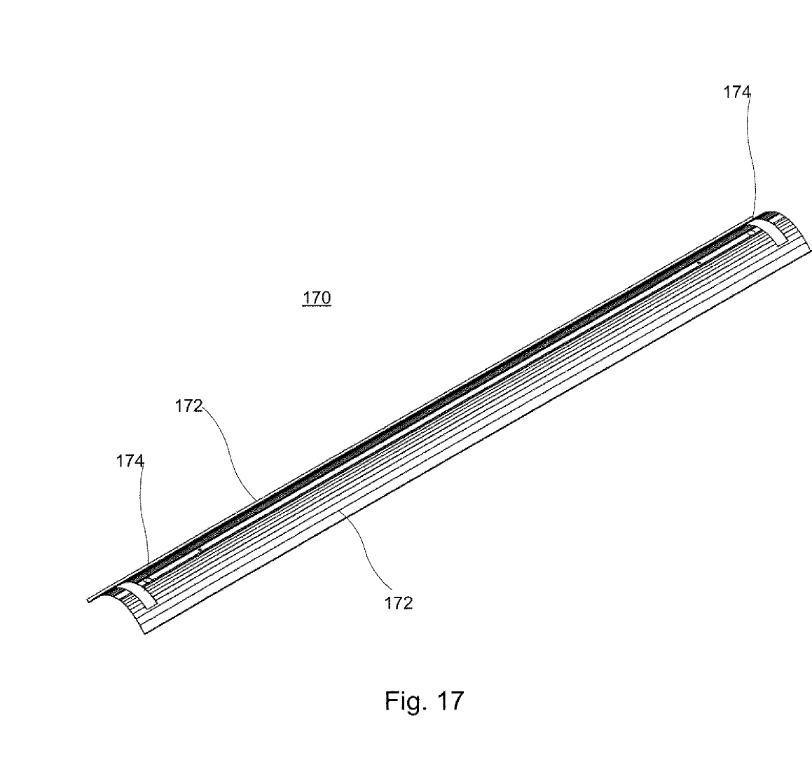

FIG. 17 is an illustration of an isometric view of a reflector for a luminaire according to another exemplary embodiment the invention.

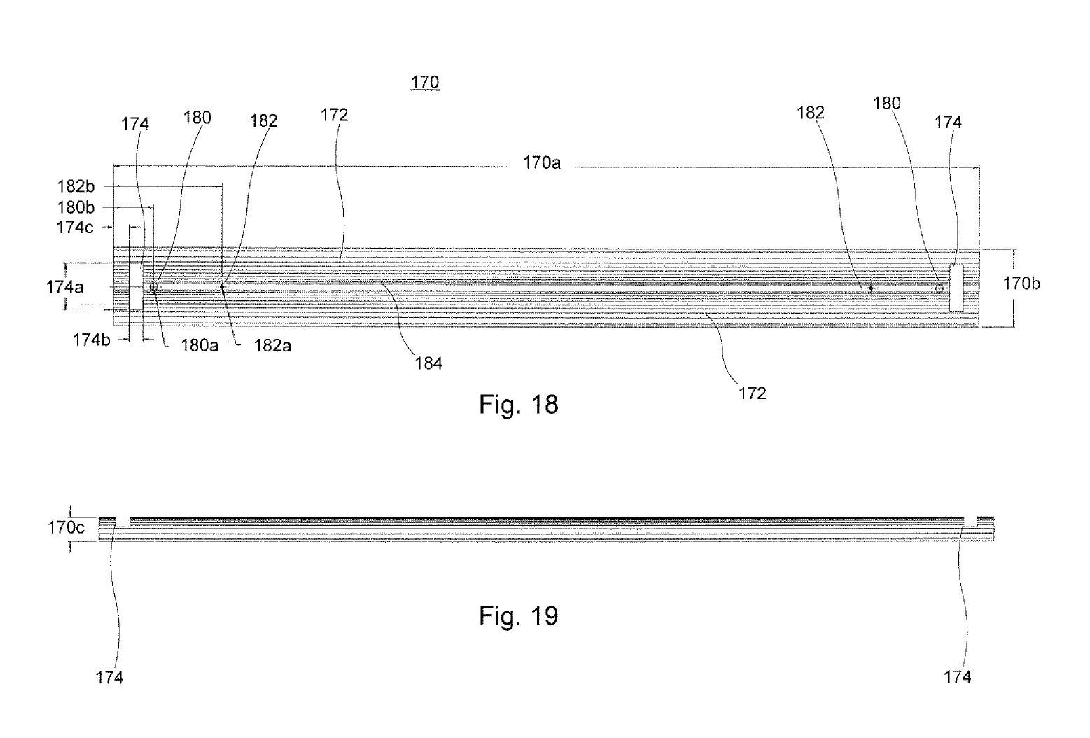

FIG. 18 is an illustration of a top view of the exemplary reflector of FIG. 17.

FIG. 19 is an illustration of a side view of the exemplary reflector of FIG. 17.

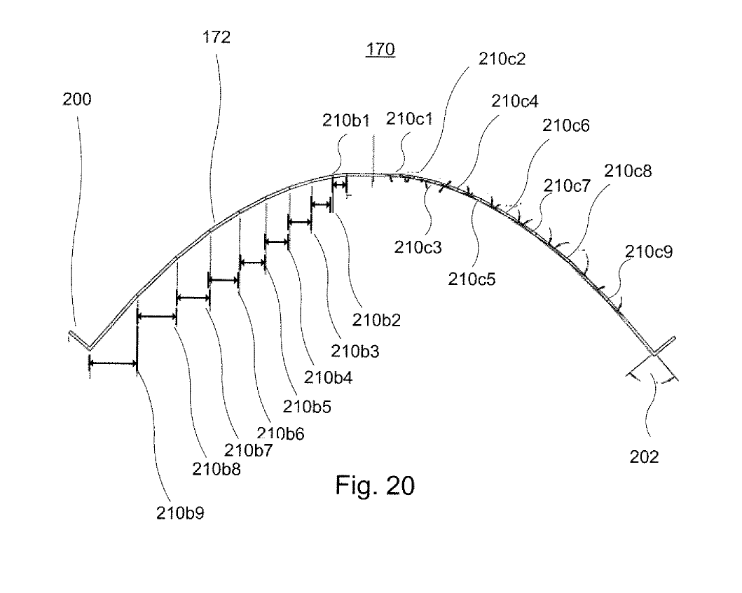

FIG. 20 is an illustration of a cross-sectional view of the exemplary reflector of FIG. 17.

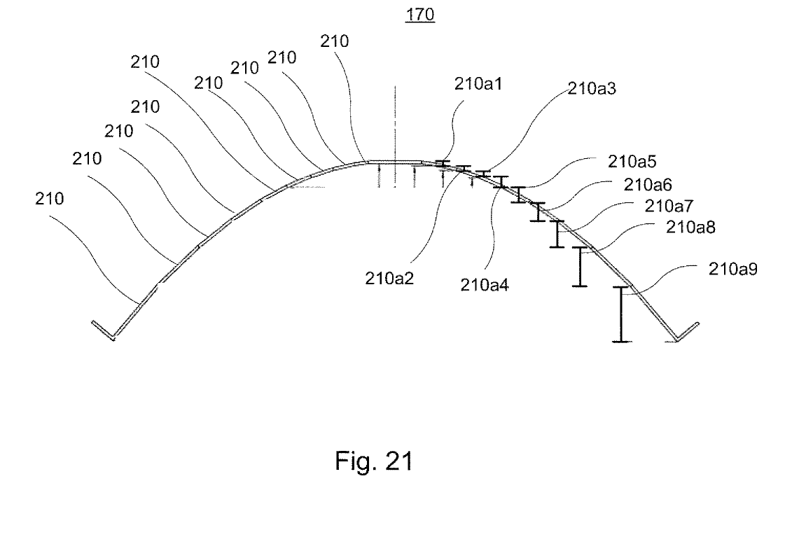

FIG. 21 is an illustration of another cross-sectional view of the exemplary reflector of FIG. 17.

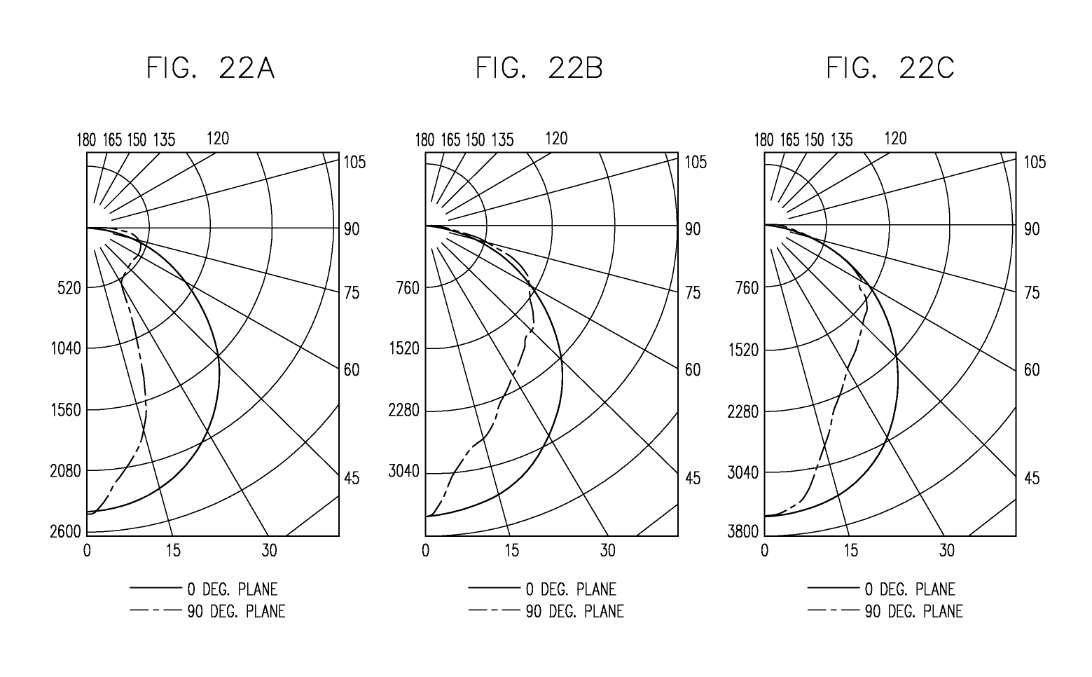

FIG. 22a is a zonal rumination plot for the exemplary reflector of FIG. 17 using one 54 watt T5 lamp rated at 4400 lumens.

FIG. 22b is a zonal lumination plot for the exemplary reflector of FIG. 17 using two 54 watt T5 lamps rated at 4400 lumens spaced 1.062 inches from the top of the reflector.

FIG. 22c is a zonal rumination plot for the exemplary reflector of FIG. 17 using two 54 watt T5 lamps rated at 4400 lumens spaced 0.875 inches from the top of the reflector.

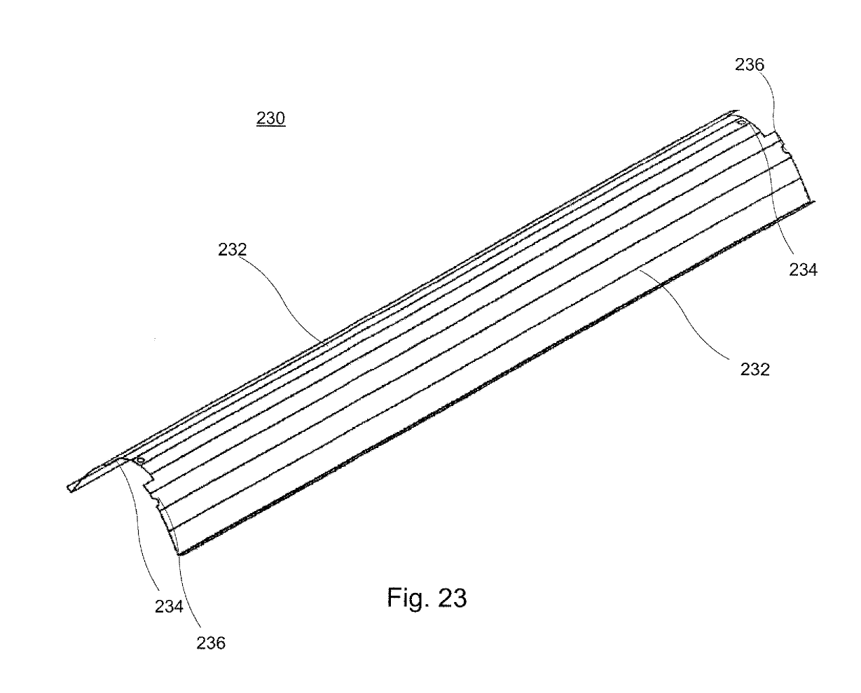

FIG. 23 is an isometric view of a reflector for a luminaire according to another exemplary embodiment the invention.

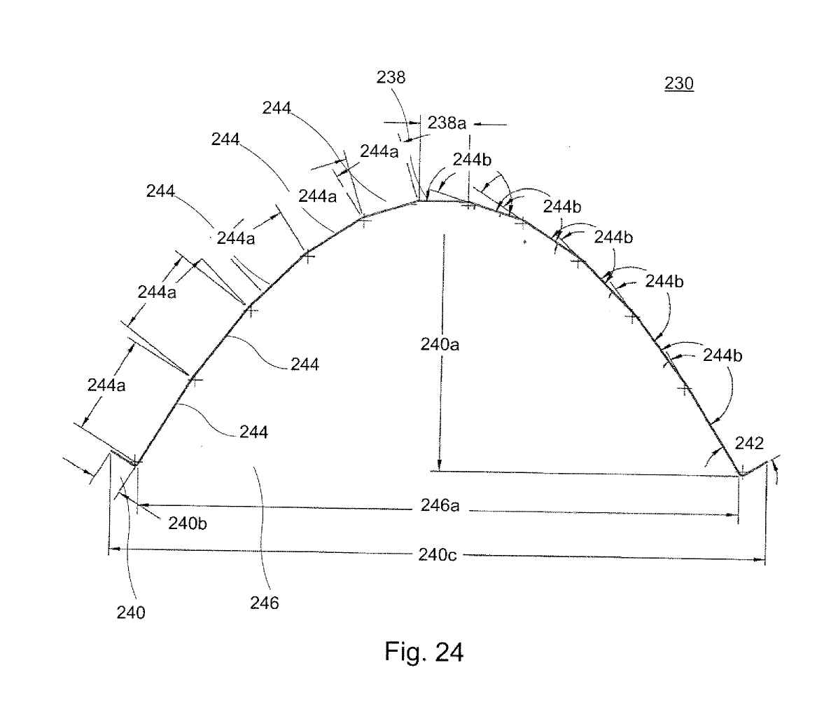

FIG. 24 is an illustration of a cross-sectional view of the exemplary reflector of FIG. 23.

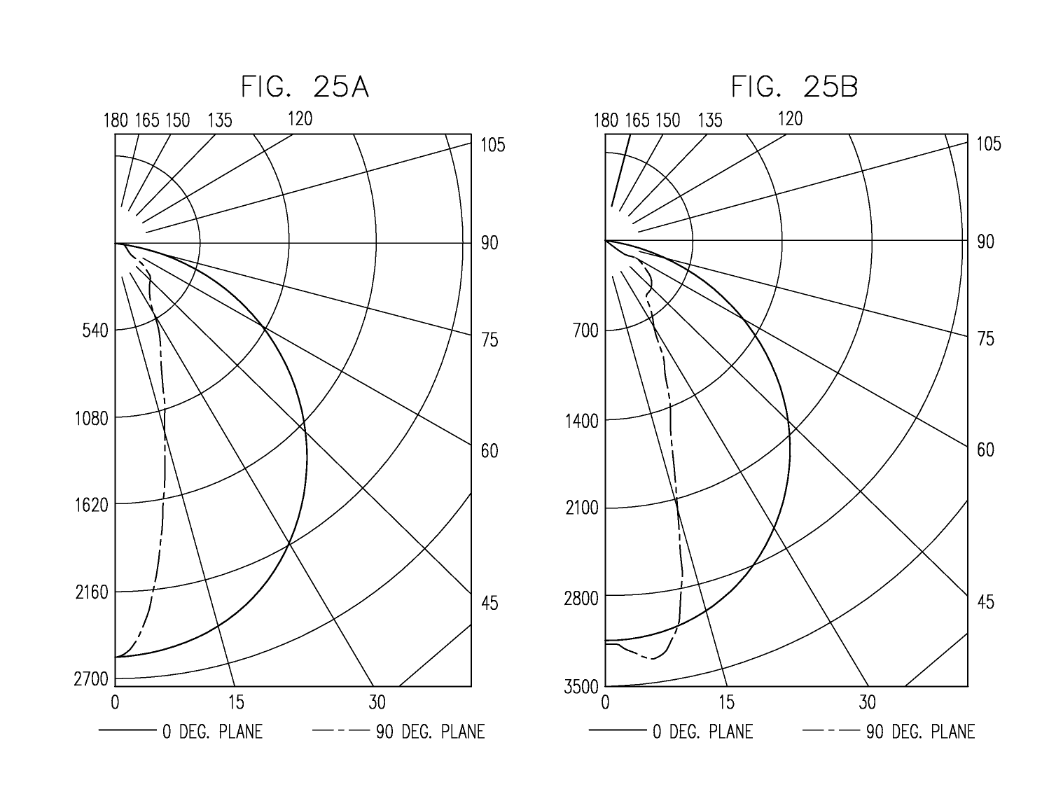

FIG. 25a is a zonal lumination plot for the exemplary reflector of FIG. 23 using a single 32 watt T8 linear fluorescent lamp rated at 2850 lumens.

FIG. 25b is a zonal rumination plot for the exemplary reflector of FIG. 23 using two 32 watt T8 linear fluorescent lamps.

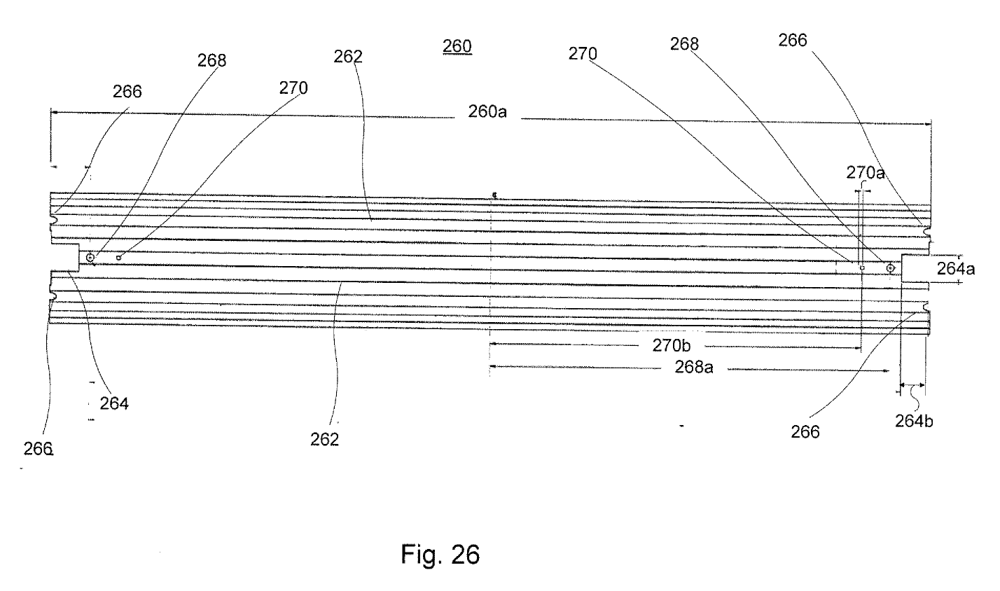

FIG. 26 is an illustration of a top view of a reflector for a luminaire according to another exemplary embodiment of the present invention.

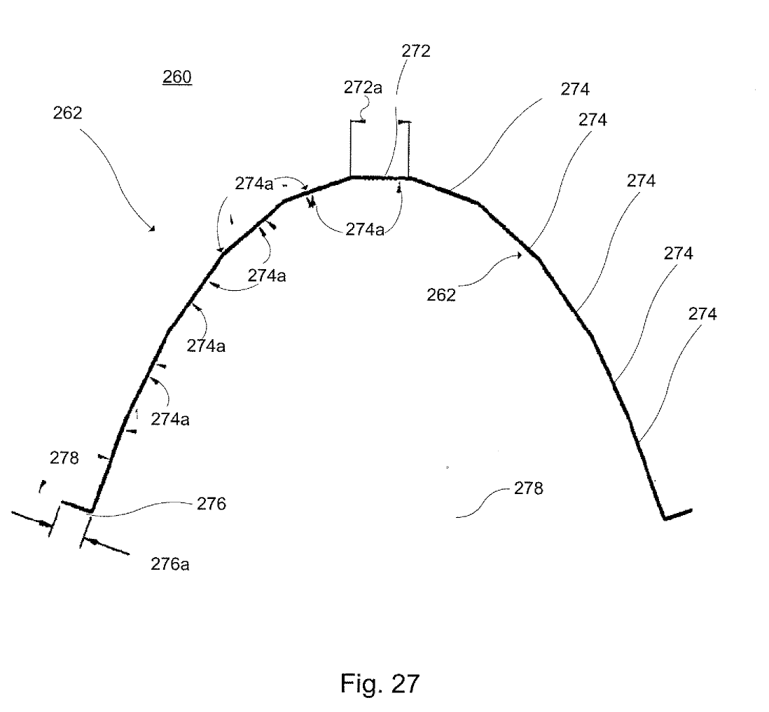

FIG. 27 is an illustration of a cross-sectional view of the reflector of FIG. 26.

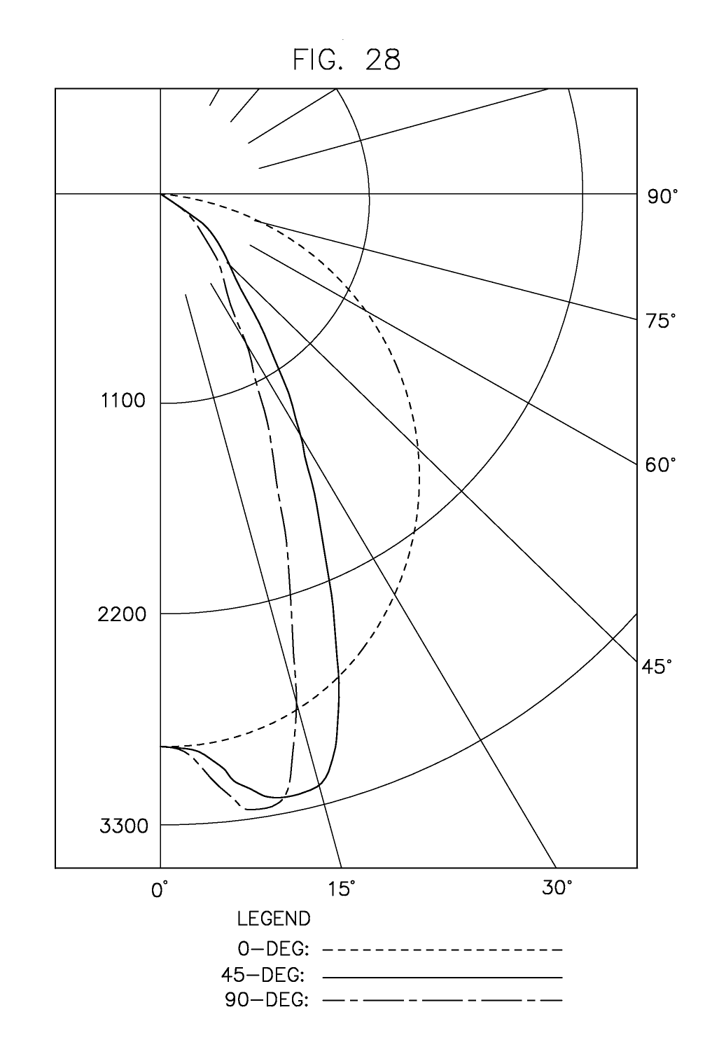

FIG. 28 is a zonal rumination chart for the exemplary reflector of FIG. 26 using a single 54 watt T5 linear fluorescent lamp rated at 4460 lumens.

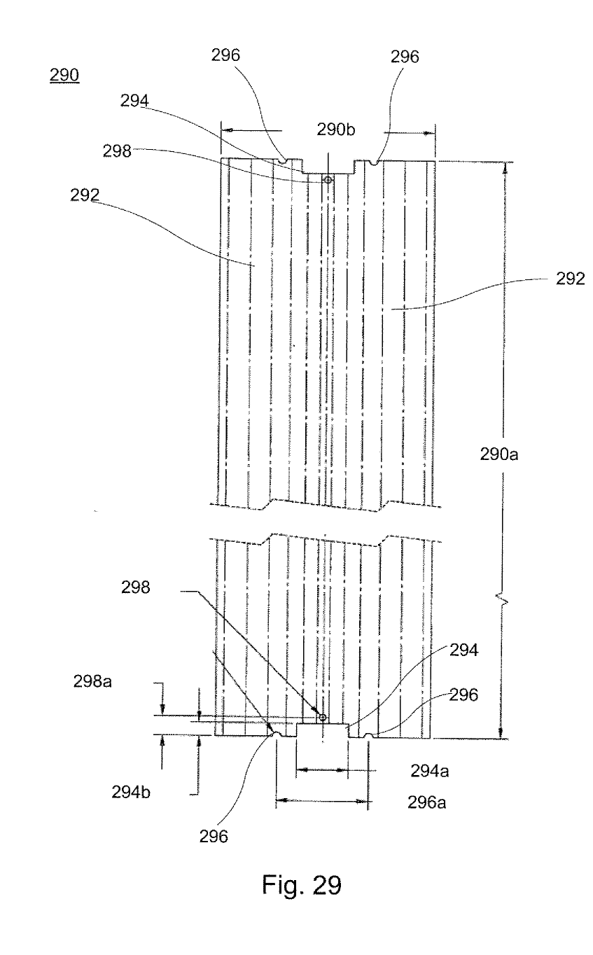

FIG. 29 is an illustration of a top view of a reflector for a luminaire according to another exemplary embodiment of the present invention.

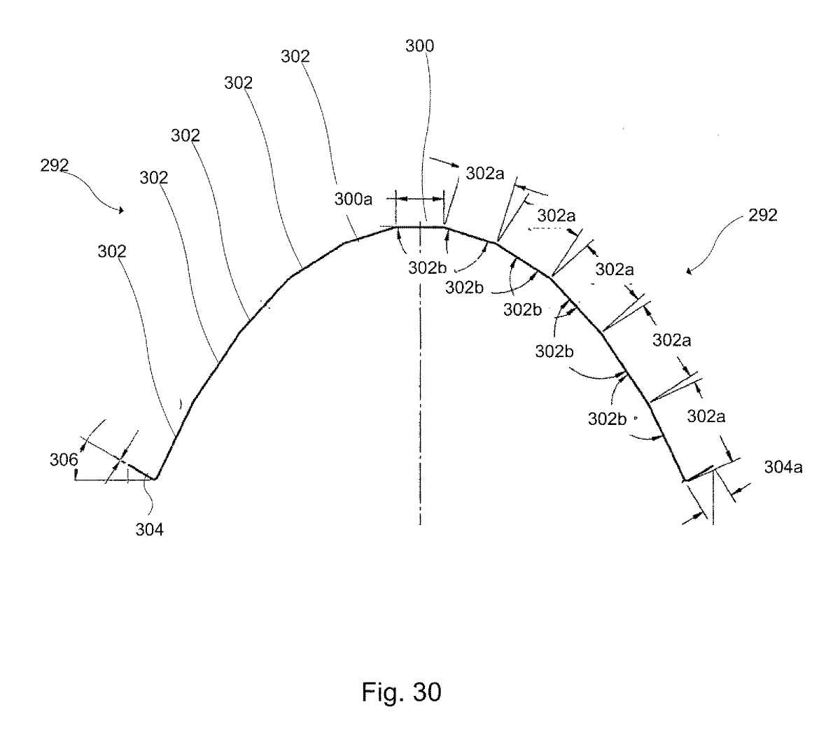

FIG. 30 is an illustration of a cross-sectional view of the reflector of FIG. 29.

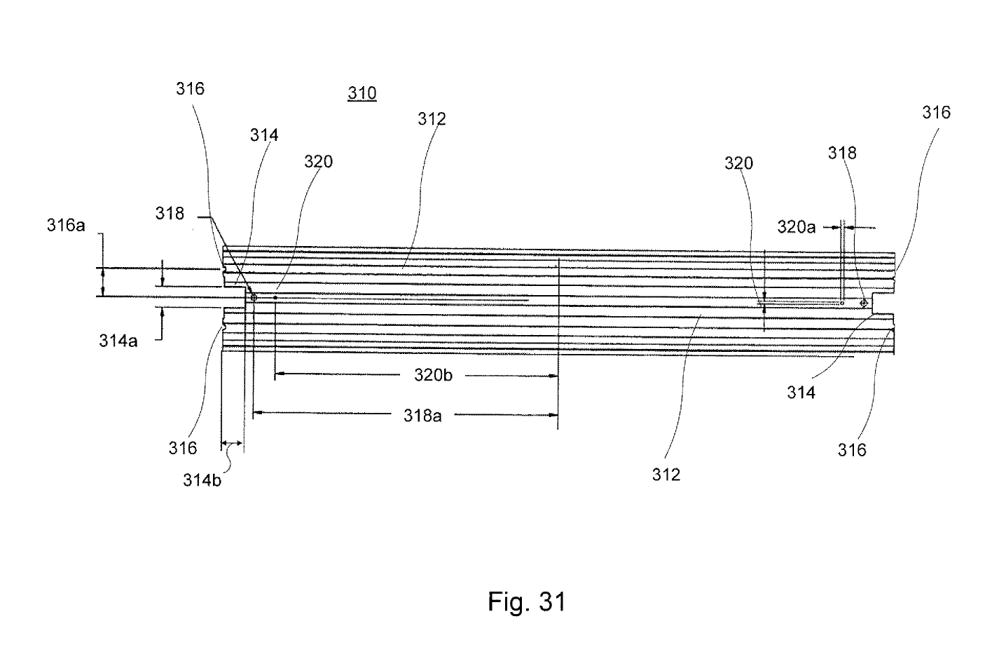

FIG. 31 is an illustration of a top view of a reflector for a luminaire according to another exemplary embodiment of the present invention.

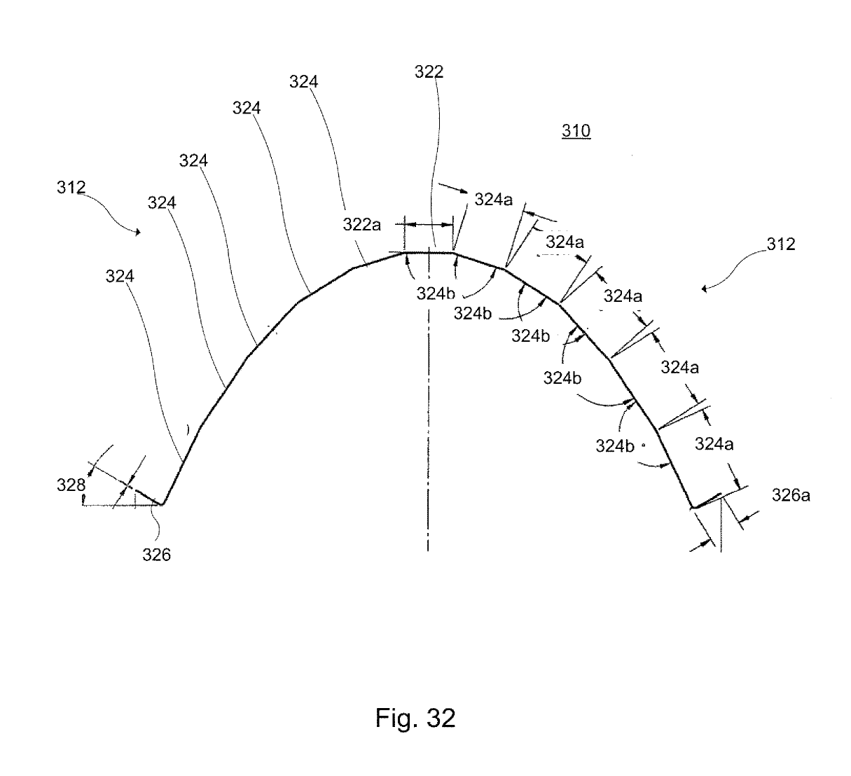

FIG. 32 is an illustration of a cross-sectional view of the reflector of FIG. 31.

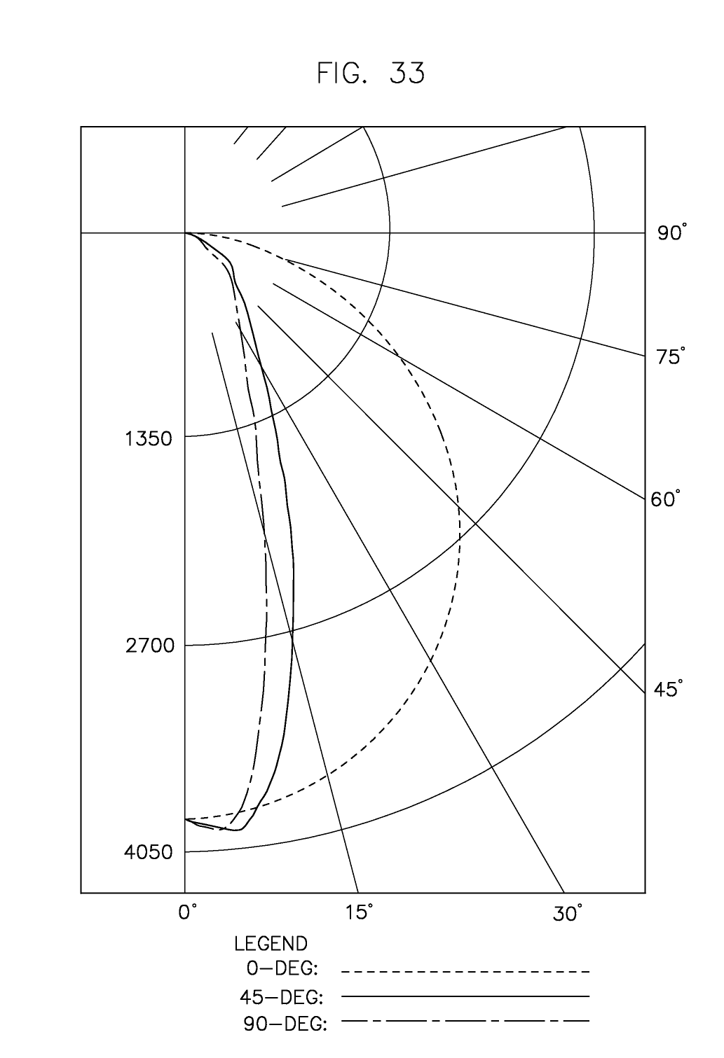

FIG. 33 is a zonal lumination chart for the exemplary reflector of FIG. 31 using a single 54 watt T5 linear fluorescent lamp rated at 4460 lumens.

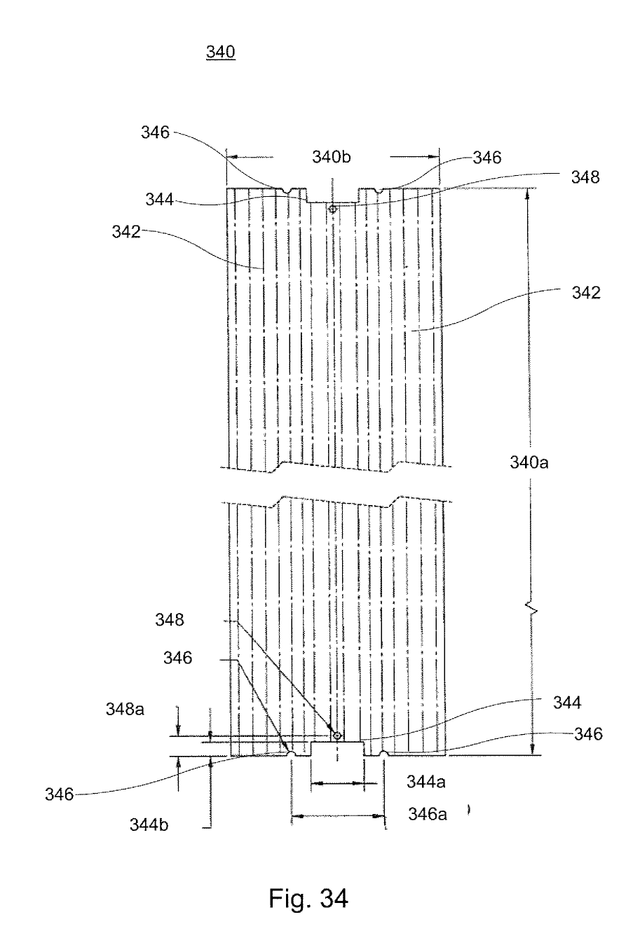

FIG. 34 is an illustration of a top view of a reflector for a luminaire according to another exemplary embodiment of the present invention.

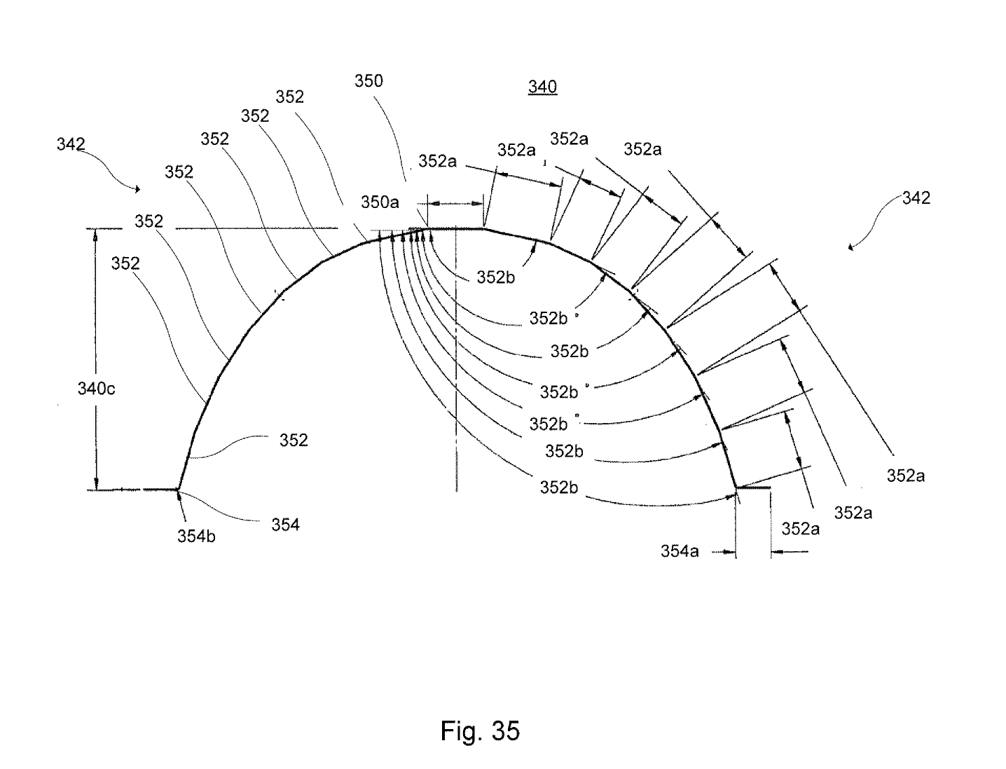

FIG. 35 is an illustration of a cross-sectional view of the reflector of FIG. 34.

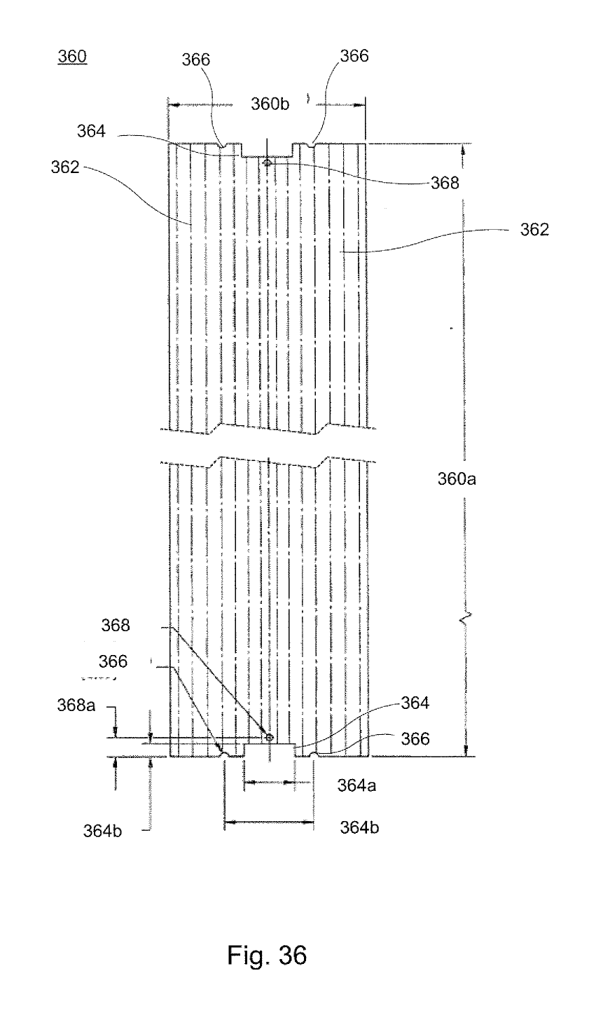

FIG. 36 is an illustration of a top view of a reflector for a luminaire according to another exemplary embodiment of the present invention.

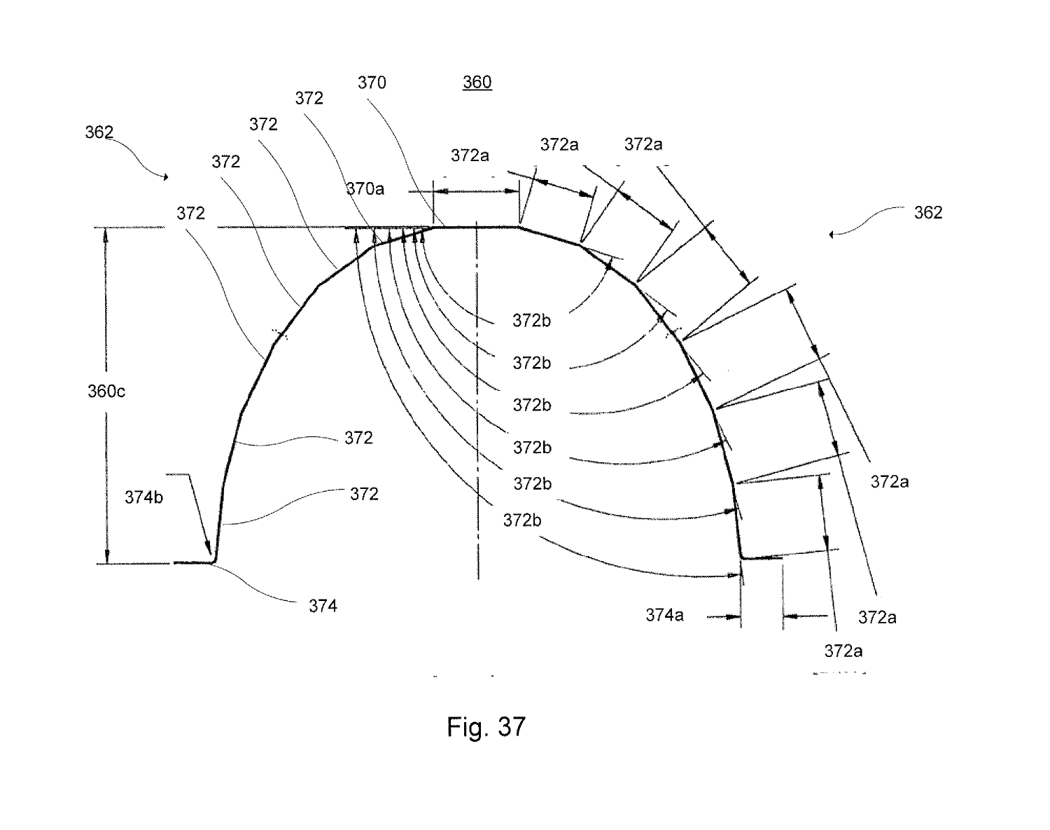

FIG. 37 is an illustration of a cross-sectional view of the reflector of FIG. 36.

### DETAILED DESCRIPTION OF EXEMPLARY EMBODIMENTS

FIG. 1 is an illustration of an isometric view of a reflector 10 for a luminaire according to an exemplary embodiment of the invention. In an exemplary embodiment, the reflector 10 may be used with a single fluorescent lamp, for example, a T8 lamp, to provide illumination in applications wherein a more focused light beam having greater intensity using lower wattage lamps is desired from a higher luminaire position. The reflector 10 has a long axis A traversing the center of the long side of the reflector 10, and a short axis B traversing the center of the short side of the reflector 10. In an exemplary embodiment, the reflector 10 is made of a reflective material such as specular aluminum. However, the reflector 10 may be formed from any material or combination of materials that provides a reflective surface on at least an inside portion of the reflector 10.

To form the reflector 10, the reflective material is shaped around the long axis as will be described in further detail hereinafter. In the exemplary embodiment illustrated in FIG. 1, the reflector 10 is shaped to form a generally flat top portion 22, which permits firm contact with a luminaire housing (not shown) and assists in enclosing wires within the luminaire housing. The reflector 10 has two sides 12 that extend from the top portion 22 of the reflector 10 in a curved manner. In addition to their curved shape, the sides 12 have multiple step-like features that traverse the length of the reflector 10. The step-like features will be described in further detail hereinafter with respect to FIG. 4.

The reflector 10 includes two socket notches 14 that allow for the installation of electrical sockets for the fluorescent lamp portion of the luminaire (not shown). The reflector 10 also includes two half-circle notches 16 on each end to assist in the installation of the reflector in a multi-strip configuration. The reflector 10 also includes two fastener holes 18 that permit the connection of the reflector 10 to the luminaire housing (not shown).

FIG. 2 is an illustration of a top view of the exemplary reflector of FIG. 1. As illustrated in FIG. 2, the socket notches 14 are located at either end of the reflector 10 and are an appropriate length 14a and width 14b to accommodate the installation of a standard socket. In an exemplary embodiment, the notches can be 3.75 inches long and 0.625 inches wide, although the notches may be of any size or shape to accommodate a socket for a fluorescent lamp. The reflector 10 has a length 10a. In an exemplary embodiment, the reflector 10 can be 48 inches long.

The half-circle notches 16 are located in pairs at each end of the reflector 10, have a diameter 16a, and are located a distance 16b from the axial center of the reflector 10 to allow a power cable (not shown) to pass through the reflector 10 to a luminaire housing (not shown) in an embodiment wherein multiple reflectors 10 are connected to one another along their ends. In an exemplary embodiment, the half-circle notches 16 can be located 2.4 inches from the axial center of the reflector and are one-half inch in diameter. However, the half-circle notches 16 may be of any diameter 16a and disposed any distance 16b appropriate to fasten the reflector 10 to a luminaire housing (not shown).

The fastener holes 18 are located along the axial center of the reflector 10 and are positioned to facilitate the connection of the reflector 10 to the luminaire housing (not shown). The fastener holes have a diameter 18a and are located a distance 18b from one another. In an exemplary embodiment, the fastener holes 18 can be approximately 0.41 inches in diameter.

The distance 18b between the fastener holes 18 can vary depending on the size of the fluorescent lamp to be used in the light fixture. In one exemplary embodiment, the luminaire can be fitted with a forty-eight inch lamp, and the distance 18b between the fastener holes 18 can be 45.752 inches. However, depending on the size of fluorescent lamp and type of luminaire housing used, the fastener holes 18 may be of any suitable size and placed in any suitable location to facilitate the connection of the reflector 10 to the luminaire housing (not shown).

FIG. 3 is an illustration of a cross-sectional view of the exemplary reflector of FIG. 1. As illustrated in FIG. 3, the reflector 10 has a flat portion 22 at the top and sides 12 that extend toward an opening 30 at the bottom of the reflector 10 that allows light to escape. The opening 30 has a width 30a, which, in an exemplary embodiment, can be 7.983 inches wide. The flat portion 22 has a width 22a. In an exemplary embodiment, the width of the flat portion 22 can be 2.788 inches. However, the flat portion may be of any suitable width that facilitates connection to such a housing, or may not be present at all.

The sides 12 initially extend in a direction away from the opening 30 at an angle 32 with respect to the top portion 22. In an exemplary embodiment the angle 32 can be forty-five degrees from horizontal, but may be any appropriate angle between zero and one hundred and eighty degrees.

The sides 12 then slope toward the opening 30 at an angle 34 to the previously-described upward extending portion. Together, the angles 32 and 34 form a substantially V-shaped structure in the reflector 10 that improves the structural integrity of the reflector, and allows for easier handling of the reflector. The vertices of the respective V-shaped structures are a distance 34a apart. In an exemplary embodiment, the vertices of the V-shaped structures can be 3.208 inches apart. In an exemplary embodiment, the angle 34 can be one hundred and eight degrees but may be any appropriate angle. As described above with reference to FIG. 1, the sides 12 slope in a generally curved shape. The sides 12 terminate in a rim 36 a distance 36a from the flat portion. In an exemplary embodiment, the sides 12 can terminate approximately 1.997 inches below the flat portion 22.

The rim 36 can be used to support a diffuser or other luminaire accessory (not shown) and also may assist in the installation of the reflector 10 in a luminaire housing (not shown). The rim 36 extends at an angle 38 from each side 12 of the reflector 10. In an exemplary embodiment, the rim 36 can extend at an angle 38 of ninety degrees from each side 12. However, the angle 38 can be any angle suitable for supporting a diffuser or other attachment (not shown) that might be coupled to the reflector 10, or for coupling the reflector 10 in a luminaire housing (not shown). The sides 12 terminate such that the vertex of the angle 38 is a vertical distance 36b from the vertex of the V-shaped structure formed by angle 34, and such that the ends of the rims are a distance 36c apart. In an exemplary embodiment, the sides 12 can terminate 2.2 inches from the vertex of the V-shaped structure formed by angle 34, and such that the rims 36 can terminate a distance 8.611 inches apart. The rims 36 themselves have a length 36d. In an exemplary embodiment, the rims 36 can be 0.273 inches long.

FIG. 4 is an illustration of another cross-sectional view of the exemplary reflector of FIG. 1. In particular, FIG. 4 shows, in detail, step-like features 40 of each side 12. The sides 12 of the reflector 10 proceed from the top portion 22 to the opening 30. The steps 40 improve the light reflecting capabilities of the reflector 10. In the exemplary embodiment illustrated in FIG. 4, the reflector has six steps 40.

The steps 40 can be manufactured in a variety of ways. In an exemplary embodiment, the reflector 10 comprises a single sheet of metal, and the steps 40 can be formed by bending the metal in appropriate locations at appropriate angles. In another exemplary embodiment, the steps 40 can be formed by assembling single strips of metal for each step 40. In yet another exemplary embodiment, the steps can be formed by bending a single sheet of metal in a shape generally approximating the curved shape as described in FIG. 4. The steps 40 are then represented by substantially forming the shape of the curve to correspond with the dimensions of the steps, as will be described in further detail below.

As shown in FIG. 4, each side 12 comprises six steps 40. Dimensions of each step 40 according to an exemplary embodiment are listed below in Table 1. Starting from the vertex of angle 34 (FIG. 3), the steps traverse toward the opening substantially as described in Table 1 below.

TABLE 1

| | Downward | Horizontal | Distance along |
|---|---|---|---|
| Step | Distance (40a) | Distance (40b) | side (40c) |
| 1 | .162 in | .301 in | .321 in |
| 2 | .196 in | .328 in | .390 in |
| 3 | .289 in | .354 in | .449 in |
| 4 | .361 in | .382 in | .527 in |
| 5 | .474 in | .418 in | .632 in |
| 6 | .721 in | .583 in | .919 in |

While the dimensions of the stepped sides of the exemplary embodiment of the reflector are described above, other combinations of numbers and sizes of steps are contemplated by the present invention. Further, while the steps 40 of the present invention are described as part of the interior surface of the reflector 10, the steps may also be present on the exterior of the reflector 10, or the exterior of the reflector 10 may be smooth.

Table 2 below provides light distribution data for a configuration of the reflector 10 in a luminaire using a single 32 watt T8 fluorescent lamp rated at 2850 lumens. Table 3 below provides zonal lumen data for this configuration of the reflector 10, and Table 4 below provides the reflector's efficiency of producing light on a horizontal surface as determined by the zonal cavity method in this configuration.

TABLE 2
Candela distribution

| | 0 | 22.5 | 45 | 67.5 | 90 | Flux |
|---|---|---|---|---|---|---|
| 0 | 2263 | 2263 | 2263 | 2263 | 2263 | |
| 5 | 2259 | 2258 | 2255 | 2227 | 2223 | 211 |
| 15 | 2169 | 2120 | 1895 | 1729 | 1691 | 541 |
| 25 | 2006 | 1768 | 1501 | 1397 | 1356 | 729 |
| 35 | 1765 | 1390 | 1186 | 1166 | 1139 | 813 |
| 45 | 1468 | 1071 | 960 | 1014 | 1025 | 832 |
| 55 | 1124 | 759 | 808 | 874 | 885 | 769 |
| 65 | 719 | 537 | 615 | 532 | 514 | 564 |
| 75 | 318 | 329 | 239 | 181 | 156 | 262 |
| 85 | 40 | 33 | 0 | 0 | 0 | 21 |
| 90 | 0 | 0 | 0 | 0 | 0 | 0 |

TABLE 3
Zonal Lumen Summary

| Zone | Lumens | % lamp | % fixt |
|---|---|---|---|
| 0-30 | 1481 | 26 | 31.2 |
| 0-40 | 2293 | 40.2 | 48.4 |
| 0-60 | 3894 | 68.3 | 82.1 |
| 0-90 | 4740 | 83.2 | 100 |
| 90-120 | 0 | 0 | 0 |
| 90-130 | 0 | 0 | 0 |
| 90-150 | 0 | 0 | 0 |
| 90-180 | 0 | 0 | 0 |
| 0-180 | 4740 | 83.2 | 100 |

TABLE 4
Zonal Cavity Method

| | RC | | | | | | | | | | | | | | | | | |
|---|---|---|---|---|---|---|---|---|---|---|---|---|---|---|---|---|---|---|
| | 80 | | | | 70 | | | | 50 | | | 30 | | | 10 | | | 0 |
| RW | 70 | 50 | 30 | 10 | 70 | 50 | 30 | 10 | 50 | 30 | 10 | 50 | 30 | 10 | 50 | 30 | 10 | 0 |
| 0 | 99 | 99 | 99 | 99 | 97 | 97 | 97 | 97 | 92 | 92 | 92 | 89 | 89 | 89 | 85 | 85 | 85 | 83 |
| 1 | 92 | 88 | 85 | 83 | 90 | 87 | 84 | 81 | 83 | 81 | 79 | 80 | 78 | 76 | 77 | 76 | 74 | 72 |
| 2 | 84 | 78 | 73 | 69 | 82 | 77 | 72 | 68 | 74 | 70 | 67 | 71 | 68 | 65 | 69 | 66 | 64 | 62 |
| 3 | 78 | 70 | 64 | 59 | 76 | 69 | 63 | 58 | 66 | 61 | 57 | 64 | 60 | 56 | 62 | 58 | 55 | 54 |
| 4 | 71 | 62 | 56 | 51 | 70 | 61 | 55 | 50 | 59 | 54 | 50 | 57 | 53 | 49 | 56 | 52 | 48 | 47 |
| 5 | 65 | 55 | 48 | 43 | 64 | 54 | 48 | 43 | 53 | 47 | 42 | 51 | 46 | 42 | 50 | 45 | 42 | 40 |
| 6 | 60 | 50 | 43 | 38 | 59 | 49 | 42 | 37 | 48 | 42 | 37 | 46 | 41 | 37 | 45 | 40 | 36 | 35 |
| 7 | 56 | 45 | 38 | 33 | 54 | 44 | 38 | 33 | 43 | 37 | 33 | 42 | 36 | 32 | 41 | 36 | 32 | 31 |
| 8 | 52 | 40 | 34 | 29 | 50 | 40 | 33 | 29 | 39 | 33 | 29 | 38 | 22 | 28 | 37 | 32 | 28 | 27 |
| 9 | 48 | 36 | 30 | 25 | 46 | 36 | 29 | 25 | 35 | 29 | 25 | 34 | 29 | 25 | 33 | 28 | 25 | 23 |
| 10 | 44 | 33 | 27 | 22 | 43 | 33 | 27 | 22 | 32 | 26 | 22 | 31 | 26 | 22 | 31 | 26 | 22 | 21 |

FIG. 5a is a zonal lumination plot for the exemplary reflector of FIG. 1 using a single 32 watt T8 linear fluorescent lamp rated at 2850 lumens.

FIG. 5b is a zonal rumination plot for the exemplary reflector of FIG. 1 using two 32 watt T8 linear fluorescent lamps rated at 2850 lumens.

FIG. 6 is an illustration of an isometric view of a reflector 60 for a luminaire according to another exemplary embodiment the invention. In an exemplary embodiment, the reflector 60 may be used with a single fluorescent lamp, such as a T8 lamp, wherein a balanced horizontal and vertical light distribution is desired, both directly below the luminaire, and in areas adjacent to the luminaire from a lower wattage lamp. In this embodiment, the reflector 60 has sides 62, socket notches 64, half-circle notches 66, and fastener holes 68 that are substantially similar to those of the embodiment described above with respect to FIGS. 1-4.

FIG. 7 illustrates a top view of the reflector 60 of FIG. 6. The socket notches 64 are located at either end of the reflector 60, and are an appropriate length 64a and width 64b to accommodate the installation of a standard socket. In an exemplary embodiment, the notches can be 3.75 inches long and 0.625 inches wide, although the socket notches 64 may be of any suitable size or shape to accommodate a socket for a fluorescent lamp. FIG. 7 also illustrates the rim 70 and flat portion 72, which will be discussed in further detail below with respect to FIG. 8. The reflector 60 has a length 60a. In an exemplary embodiment, the reflector 60 can be 48 inches long.

The half-circle notches 66 are located in pairs at each end of the reflector and have a diameter 66a and are located a distance 66b from the axial center of the reflector 60 to allow a power cable (not shown) to pass through the reflector 60 to a luminaire housing (not shown) in an embodiment wherein multiple reflectors 60 are connected to one another along their ends. In an exemplary embodiment, the half-circle notches 66 can be located 2.4 inches from the axial center of the reflector and can be one-half inch in diameter. However, the half-circle notches 66 may be of any diameter 66a and in any distance 66b appropriate to fasten the reflector 60 to a luminaire housing (not shown) or another reflector.

The fastener holes 68 are located along the axial center of the reflector 60 and are positioned in order to facilitate the connection of the reflector 60 to the luminaire housing (not shown). The fastener holes have a diameter 68a and are located a distance 68b from one another. in this embodiment, the fastener holes 68 can be approximately 0.41 inches in diameter.

The distance 68b between the fastener holes 68 varies depending on the size of the fluorescent lamp to be used in the light fixture. In one exemplary embodiment, the luminaire can be fitted with a forty-eight inch lamp, and the distance 68b between the fastener holes 68 can be 45.752 inches. However, depending on the size of fluorescent lamp and type of luminaire housing used, the fastener holes may be of any size and placed in any location to facilitate the connection of the reflector 60 to the luminaire housing (not shown).

FIGS. 8 and 9 are illustrations of cross-sectional views of the reflector 60 from a cutaway view. The reflector 60 has a rim 70, flat portion 72, and sides 62 opening downward toward an opening 82 that are substantially similar to the corresponding features as described above with respect to FIGS. 3-4. The flat portion 72 has a width 72a, which in an exemplary embodiment can be 2.767 inches. A distinction between this embodiment and the embodiment described in FIGS. 1-4 is the angle and size of the sides 62, and the number and size of the steps 100, which will be discussed in further detail with respect to FIG. 10, below.

As illustrated in FIG. 9, the sides 62 initially extend in a direction away from the opening 82 at an angle 84 with respect to the top portion 72. In an exemplary embodiment the angle 84 can be thirty degrees from horizontal, but may be any suitable angle between zero and one hundred and eighty degrees.

The sides 62 then slope toward the opening 82 at an angle 86 to the previously-described upward extending portion. Together, the angles 84 and 86 form a substantially V-shaped structure in the reflector 60. In an exemplary embodiment, the angle 84 can be thirty degrees from horizontal, and the angle 86 can be 124 degrees from the upward extending portion arising from the vertex of angle 84.

The sides 62 terminate at the rim 70 a vertical distance 70a from the vertex of angle 86. In the exemplary embodiment, the sides 62 can terminate approximately 1.401 inches from the vertex of angle 86. The vertices of the angles 86 are a distance 86a apart. In an exemplary embodiment, the vertices of angles 86 can be 3.395 inches apart. The rim 70 extends at an angle 88 that, in an exemplary embodiment, can be approximately seventy-five degrees from the terminus of the sides 62. The rims 70 terminate such that the ends of the rims 70 are a distance 70b apart. In an exemplary embodiment, the rims 70 can terminate 7.562 inches apart. The rims 70 also have a length 70c. In an exemplary embodiment, the rims 70 can be 0.44 inches long.

As illustrated in FIGS. 8 and 10, each side 62 of the reflector 60 in this embodiment comprises eight steps 100. The steps may take a number of forms as previously described above with respect to FIGS. 3-4. The dimensions of each step are listed below in Table 5.

TABLE 5

| | Downward | | Horizontal | Distance along |
|---|---|---|---|---|
| Step | Distance (100a) | | Distance (100b) | side (100c) |
| 1 | .074 | in | .151 in | .172 in |
| 2 | 0.109 | in | .196 in | .226 in |
| 3 | 0.11 | in | .201 in | .241 in |
| 4 | 0.173 | in | .208 in | .259 in |
| 5 | .179 | in | .214 in | .280 in |
| 6 | .212 | in | .213 in | .302 in |
| 7 | .231 | in | .213 in | .331 in |
| 8 | .287 | in | .167 in | .372 in |

Table 6 below provides light distribution data for a configuration of the reflector 60 in a luminaire using a single 32 watt T8 fluorescent lamp rated at 2850 lumens. Table 7 below provides zonal lumen data for the configuration of the reflector 60, and Table 8 below provides the reflector's efficiency of producing light on a horizontal surface as determined by the zonal cavity method.

TABLE 6
Candela distribution

| | 0 | 22.5 | 45 | 67.5 | 90 | Flux |
|---|---|---|---|---|---|---|
| 0 | 2063 | 2063 | 2063 | 2063 | 2063 | |
| 5 | 2046 | 2046 | 2042 | 2029 | 2027 | 194 |
| 15 | 1971 | 1955 | 1963 | 1870 | 1828 | 539 |
| 25 | 1822 | 1812 | 1551 | 1400 | 1386 | 736 |
| 35 | 1605 | 1475 | 1221 | 1124 | 1132 | 815 |
| 45 | 1335 | 1066 | 955 | 1035 | 1065 | 824 |
| 55 | 1022 | 764 | 836 | 932 | 969 | 788 |
| 65 | 684 | 534 | 694 | 730 | 725 | 654 |
| 75 | 339 | 367 | 392 | 391 | 395 | 401 |
| 85 | 51 | 103 | 115 | 120 | 123 | 121 |
| 90 | 1 | 18 | 23 | 28 | 31 | |
| 95 | 0 | 5 | 2 | 1 | 1 | 4 |
| 105 | 0 | 1 | 0 | 0 | 0 | 0 |

TABLE 7
Zonal Lumen Summary

| Zone | Lumens | % lamp | % fixt |
|---|---|---|---|
| 0-30 | 1469 | 25.8 | 28.9 |
| 0-40 | 2284 | 40.1 | 45 |
| 0-60 | 3896 | 68.4 | 76.7 |
| 0-90 | 5073 | 89 | 99.9 |
| 90-120 | 4 | 0.1 | 0.1 |
| 90-130 | 4 | 0.1 | 0.1 |
| 90-150 | 4 | 0.1 | 0.1 |
| 90-180 | 4 | 0.1 | 0.1 |
| 0-180 | 5077 | 89.1 | 100 |

TABLE 8
Zonal Cavity Method

| | RC | | | | | | | | | | | | | | | | | |
|---|---|---|---|---|---|---|---|---|---|---|---|---|---|---|---|---|---|---|
| | 80 | | | | 70 | | | | 50 | | | 30 | | | 10 | | | 0 |
| RW | 70 | 50 | 30 | 10 | 70 | 50 | 30 | 10 | 50 | 30 | 10 | 50 | 30 | 10 | 50 | 30 | 10 | 0 |
| 0 | 106 | 106 | 106 | 106 | 104 | 104 | 104 | 104 | 99 | 99 | 99 | 95 | 95 | 95 | 91 | 91 | 91 | 89 |
| 1 | 97 | 93 | 90 | 86 | 95 | 91 | 88 | 85 | 87 | 85 | 82 | 84 | 82 | 80 | 81 | 79 | 77 | 75 |
| 2 | 89 | 82 | 76 | 71 | 86 | 80 | 75 | 70 | 77 | 72 | 68 | 74 | 70 | 67 | 71 | 68 | 65 | 63 |
| 3 | 81 | 72 | 65 | 60 | 79 | 71 | 65 | 59 | 68 | 63 | 58 | 66 | 61 | 57 | 64 | 60 | 56 | 54 |
| 4 | 75 | 64 | 57 | 51 | 73 | 63 | 56 | 51 | 61 | 55 | 50 | 59 | 54 | 49 | 57 | 52 | 49 | 47 |
| 5 | 68 | 57 | 49 | 43 | 66 | 56 | 49 | 43 | 54 | 48 | 43 | 52 | 47 | 42 | 51 | 46 | 42 | 40 |
| 6 | 63 | 51 | 43 | 38 | 61 | 50 | 43 | 37 | 49 | 42 | 37 | 47 | 41 | 37 | 46 | 41 | 36 | 35 |
| 7 | 58 | 46 | 38 | 33 | 57 | 45 | 38 | 33 | 44 | 37 | 33 | 43 | 37 | 32 | 42 | 36 | 32 | 30 |
| 8 | 54 | 42 | 34 | 29 | 52 | 41 | 34 | 29 | 40 | 33 | 28 | 39 | 33 | 28 | 38 | 32 | 28 | 26 |
| 9 | 50 | 37 | 30 | 25 | 48 | 37 | 30 | 25 | 36 | 29 | 25 | 35 | 29 | 25 | 34 | 29 | 25 | 23 |
| 10 | 46 | 34 | 27 | 22 | 45 | 34 | 27 | 22 | 33 | 26 | 22 | 32 | 26 | 22 | 31 | 26 | 22 | 20 |

FIG. 11a is a zonal rumination plot for the exemplary reflector of FIG. 6 using a single 32 watt T8 linear fluorescent lamp rated at 2850 lumens.

FIG. 11b is a zonal rumination plot for the exemplary reflector of FIG. 6 using two 32 watt T8 linear fluorescent lamps, each rated at 2850 lumens.

FIG. 12 is an illustration of an isometric view of a reflector for a luminaire according to another exemplary embodiment of the invention. In an exemplary embodiment, the reflector 120 may be used with a single fluorescent lamp wherein a light pattern having a wide distribution while directing moderate intensity light to the area below the luminaire using a lower wattage lamp. As illustrated in FIG. 12, the reflector 120 has sides 122, socket notches 124, half-circle notches 126, and fastener holes 128 that are substantially similar to those of the embodiment described above with respect to FIGS. 1-4. The reflector itself has a length 120a. In an exemplary embodiment, the reflector can be 48 inches long.

FIG. 13 is an illustration of a top view of the exemplary reflector of FIG. 12. The socket notches 124 are located at either end of the reflector 120, and are an appropriate length 124a and width 124b to accommodate the installation of a standard socket. In an exemplary embodiment, the socket notches 124 can be 3.75 inches long and 0.625 inches wide, although the socket notches 124 may be of any size or shape necessary to accommodate a socket for a fluorescent lamp.

The half-circle notches 126 are located in pairs at each end of the reflector and have a diameter 126a and are located a distance 126b from the axial center of the reflector 120 to allow a power cable (not shown) to pass through the reflector 120 to a luminaire housing (not shown) in an embodiment wherein multiple reflectors 120 are connected to one another along their ends. In an exemplary embodiment, the half-circle notches 126 can be located 2.4 inches from the axial center of the reflector and can be one-half inch in diameter. However, the half-circle notches 126 may be of any diameter 126a and in any distance 126b from the center of the reflector 120 that is appropriate to fasten the reflector 120 to a luminaire housing (not shown).

The fastener holes 128 are located along the axial center of the reflector 120 and are positioned in order to facilitate the connection of the reflector 120 to the luminaire housing (not shown). The fastener holes have a diameter 128a and are located a distance 128b from one another. In this embodiment, the fastener holes 128 can be approximately 0.41 inches in diameter.

The distance 128b between the fastener holes 128 varies depending on the size of the fluorescent lamp to be used in the light fixture. In one exemplary embodiment, the luminaire can be fitted with a forty-eight inch lamp, and the distance between the fastener holes 128 can be 45.752 inches. However, depending on the size of fluorescent lamp and type of luminaire housing used, the fastener holes 128 may be of any size and placed in any location to facilitate the connection of the reflector 120 to the luminaire housing (not shown).

FIG. 14 is an illustration of a cross-sectional view of the exemplary reflector 120 of FIG. 12. The reflector 120 has a rim 140, flat portion 142 having a width 142a, and sides 122 that are substantially similar to the corresponding features described above with respect to FIGS. 3-4. In this embodiment, the angle 144 can be thirty degrees from horizontal, and the angle 146 can be 121 degrees from the upward extending portion arising from the vertex of angle 148. In this embodiment, the sides 122 terminate at the rim 140 a vertical distance 140a from the vertex of angle 146. In the exemplary embodiment, the sides 144 can terminate approximately 1.373 inches from the vertex of angle 146. The rim 140 extends at an angle 148 that can be approximately seventy-five degrees from the terminus of the sides 122. The rim 140 has a length 140c such that the rims 140 terminate a distance 140b from one another. In an exemplary embodiment, the rims 140 can be 0.414 inches long and can terminate 7.103 inches apart.

As shown in FIG. 15, each side 122 of this embodiment comprises eight steps 150. The steps may take any number of forms as previously described above with respect to FIGS. 3-4. The dimensions of each step are listed below in Table 9.

TABLE 9

| | | | Horizontal | Distance along |
|---|---|---|---|---|
| Step | Downward Distance (150a) | | Distance (150b) | side (150c) |
| 1 | .074 | in | .151 in | .172 in |
| 2 | 0.109 | in | .196 in | .226 in |
| 3 | 0.11 | in | .201 in | .241 in |
| 4 | 0.173 | in | .208 in | .259 in |
| 5 | .179 | in | .214 in | .280 in |
| 6 | .212 | in | .213 in | .302 in |
| 7 | .231 | in | .213 in | .331 in |
| 8 | .287 | in | .167 in | .372 in |

Table 10 below provides light distribution data for a configuration of the reflector 120 in a luminaire using a single 32 watt T8 fluorescent lamp rated at 2850 lumens. Table 11 below provides zonal lumen data for the configurations of the reflector 120, and Table 12 below provides the reflector's 120 efficiency of producing light on a horizontal surface as determined by the zonal cavity method.

TABLE 10
Candela distribution

| | 0 | 22.5 | 45 | 67.5 | 90 | Flux |
|---|---|---|---|---|---|---|
| 0 | 889 | 889 | 889 | 889 | 889 | |
| 5 | 900 | 896 | 934 | 956 | 963 | 90 |
| 15 | 869 | 950 | 1008 | 944 | 921 | 267 |
| 25 | 809 | 932 | 803 | 710 | 687 | 366 |
| 35 | 719 | 744 | 589 | 600 | 628 | 411 |
| 45 | 605 | 541 | 535 | 627 | 645 | 449 |
| 55 | 470 | 365 | 504 | 548 | 560 | 432 |
| 65 | 316 | 311 | 384 | 353 | 343 | 342 |
| 75 | 154 | 204 | 223 | 277 | 280 | 238 |
| 85 | 19 | 74 | 89 | 95 | 98 | 87 |
| 90 | 2 | 11 | 11 | 13 | 14 | |
| 95 | 0 | 5 | 0 | 0 | 0 | 1 |

TABLE 11
Zonal Lumen Summary

| Zone | Lumens | % lamp | % fixt |
|---|---|---|---|
| 0-30 | 723 | 25.4 | 26.9 |
| 0-40 | 1134 | 39.8 | 42.3 |
| 0-60 | 2015 | 70.7 | 75.1 |
| 0-90 | 2682 | 94.1 | 99.9 |
| 90-120 | 2 | 0.1 | 0.1 |
| 90-130 | 2 | 0.1 | 0.1 |
| 90-150 | 2 | 0.1 | 0.1 |
| 90-180 | 2 | 0.1 | 0.1 |
| 0-180 | 2684 | 94.2 | 100 |

TABLE 12
Zonal Cavity Method

| | RC | | | | | | | | | | | | | | | | | |
|---|---|---|---|---|---|---|---|---|---|---|---|---|---|---|---|---|---|---|
| | 80 | | | | 70 | | | | 50 | | | 30 | | | 10 | | | 0 |
| RW | 70 | 50 | 30 | 10 | 70 | 50 | 30 | 10 | 50 | 30 | 10 | 50 | 30 | 10 | 50 | 30 | 10 | 0 |
| 0 | 112 | 112 | 112 | 112 | 109 | 109 | 109 | 109 | 105 | 105 | 105 | 100 | 100 | 100 | 96 | 96 | 96 | 94 |
| 1 | 102 | 98 | 94 | 90 | 100 | 96 | 92 | 89 | 92 | 89 | 86 | 88 | 85 | 83 | 85 | 83 | 81 | 79 |
| 2 | 93 | 85 | 79 | 73 | 91 | 84 | 78 | 73 | 80 | 75 | 71 | 77 | 73 | 69 | 74 | 71 | 68 | 66 |
| 3 | 85 | 75 | 68 | 62 | 83 | 74 | 67 | 61 | 71 | 65 | 60 | 68 | 63 | 59 | 66 | 62 | 58 | 56 |
| 4 | 78 | 67 | 59 | 52 | 76 | 66 | 58 | 52 | 63 | 57 | 51 | 61 | 55 | 51 | 59 | 54 | 50 | 48 |
| 5 | 71 | 59 | 50 | 44 | 69 | 58 | 50 | 44 | 56 | 49 | 43 | 54 | 48 | 43 | 52 | 47 | 42 | 40 |
| 6 | 66 | 53 | 44 | 38 | 64 | 52 | 44 | 38 | 50 | 43 | 38 | 49 | 42 | 37 | 47 | 41 | 37 | 35 |
| 7 | 60 | 48 | 39 | 33 | 59 | 47 | 39 | 33 | 45 | 38 | 33 | 44 | 37 | 33 | 43 | 37 | 32 | 30 |
| 8 | 56 | 43 | 35 | 29 | 54 | 42 | 34 | 29 | 41 | 34 | 29 | 40 | 33 | 28 | 38 | 33 | 28 | 26 |
| 9 | 51 | 38 | 30 | 25 | 50 | 38 | 30 | 25 | 37 | 30 | 25 | 36 | 29 | 25 | 35 | 29 | 25 | 23 |
| 10 | 48 | 35 | 27 | 22 | 47 | 34 | 27 | 22 | 33 | 27 | 22 | 33 | 26 | 22 | 32 | 26 | 22 | 20 |

FIG. 16a is a zonal rumination plot for the exemplary reflector of FIG. 12 using a single 32 watt T8 linear fluorescent lamp rated at 2850 lumens.

FIG. 16b is a zonal rumination plot for the exemplary reflector of FIG. 12 using two 32 watt T8 linear fluorescent lamps, each rated at 2850 lumens.

FIG. 17 is an illustration of an isometric view of a reflector 170 for a luminaire according to another exemplary embodiment the invention. As illustrated in FIG. 17, the reflector 170 of this embodiment differs from the embodiments described in FIGS. 1-16 in that this embodiment is designed for a luminaire that uses a T5-type fluorescent lamp, which is smaller than the T8 and T12-type fluorescent lamps that are more commonly used in industrial lighting applications. Nonetheless, the reflector 170 is designed such that it can be accommodated by a standard luminaire housing. In this embodiment, the reflector 170 has sides 172 and socket notches 174. The sides 172 extend generally downward from the top of the reflector 170 in a parabolic manner.

FIG. 18 is an illustration of a top view of the exemplary reflector 170 of FIG. 17. As FIG. 18 illustrates, this embodiment has two large fastener holes 180 and two small fastener holes 182 disposed on a flat portion 184. This view also shows that the socket notches 174 are in a different configuration from the socket notches of the reflectors described above. Each socket notch 174 is a rectangular opening in the reflector of a height 174a and a width 174b. In an exemplary embodiment, the socket notches 174 can be approximately 2.6 inches long and 0.75 inches wide. In the exemplary embodiment, each socket notch 174 is located a distance 174c from the respective ends of the reflector 170. In the exemplary embodiment, each socket notch 174 can be disposed approximately 0.884 inches away from each end of the reflector 170. However, the socket notches 174 can be any shape or size appropriate to accommodate a socket for a fluorescent lamp. The reflector itself has a length 170a and a width 170b which, in an exemplary embodiment, can be 48 inches and 4.305 inches, respectively.

In the exemplary embodiment, the large fastener holes 180 have a diameter 180a and are centered a distance 180b from the end of the reflector 170. In the exemplary embodiment, the large fastener holes 180 can be approximately 0.408 inches in diameter, and can be located substantially along the center of the reflector 170, centered approximately 2.223 inches from each end. The small fastener holes 182 have a diameter 182a and are centered a distance 182b from the end of the reflector 170. In an exemplary embodiment, the small fastener holes 182 can be approximately 0.15 inches in diameter, and can be located essentially along the center of the reflector 170, centered approximately five inches from each end. However, the large and small fastener holes 180 and 182 can be in any size and any configuration appropriate to facilitate connection to a luminaire housing.

FIG. 19 is an illustration of a side view of the exemplary reflector 170 of FIG. 17. As FIG. 19 illustrates, the reflector 170 has a height 170c. In the exemplary embodiment, the reflector 170 can have a height of approximately 1.288 inches. FIG. 19 further illustrates the configuration of the socket notches 174 with respect to the curvature of the reflector 170.

FIGS. 20 and 21 illustrate cross-sectional views of the exemplary reflector 170 of FIG. 17. The reflector 170 has sides 172 that extend downward in a substantially parabolic fashion. The reflector 170 has a rim 200 and sides 172 that are substantially similar to the corresponding features described above with respect to FIGS. 3-4. A notable difference between the present embodiment and the embodiments previously described, as can be seen particularly with respect to FIGS. 20 and 21, is the smaller size of the flat portion 184 at the top of the reflector 170 and the absence of a V-shaped structure between the top portion and the sides.

The rim 200 extends at an angle 202 that can be approximately ninety degrees from the terminus of the sides 172. As shown in FIG. 21, each side of this embodiment comprises nine steps 210. The steps may take any number of forms as previously described above with respect to FIGS. 3-4. The dimensions of each step in the exemplary embodiment are listed below in table 13.

TABLE 13

| | | Horizontal | Angle from |
|---|---|---|---|
| Step | Downward Distance (210a) | Distance (210b) | prior step (210c) |
| 1 | 0.034 | 0.1 | 172° |
| 2 | 0.034 | 0.149 | 175° |
| 3 | 0.052 | 0.157 | 175° |
| 4 | 0.073 | 0.169 | 175° |
| 5 | 0.101 | 0.184 | 175° |
| 6 | 0.138 | 0.206 | 175° |
| 7 | 0.191 | 0.235 | 175° |
| 8 | 0.271 | 0.277 | 175° |
| 9 | 0.394 | 0.336 | 175° |

Table 14 below provides light distribution data for a configuration of the reflector 170 in a luminaire using a single 54 watt T5 fluorescent lamp rated at 4400 lumens. Table 15 below provides zonal lumen data for this configuration of the reflector 170, and Table 16 below provides the reflector's efficiency of producing light on a horizontal surface as determined by the zonal cavity method.

TABLE 14
Candela distribution

| | 0 | 22.5 | 45 | 67.5 | 90 | Flux |
|---|---|---|---|---|---|---|
| 0 | 2638 | 2638 | 2638 | 2638 | 2638 | |
| 5 | 2593 | 2586 | 2520 | 2446 | 2427 | 235 |
| 15 | 2496 | 2286 | 2133 | 2001 | 1950 | 605 |
| 25 | 2307 | 1964 | 1564 | 1102 | 962 | 718 |
| 35 | 2021 | 1540 | 738 | 573 | 562 | 652 |
| 45 | 164 | 901 | 464 | 497 | 521 | 574 |
| 55 | 1261 | 386 | 407 | 491 | 524 | 489 |
| 65 | 819 | 243 | 383 | 487 | 529 | 445 |
| 75 | 393 | 187 | 363 | 487 | 532 | 390 |
| 85 | 42 | 131 | 181 | 209 | 217 | 176 |
| 90 | 0 | 16 | 38 | 57 | 61 | |

TABLE 15
Zonal Lumen Summary

| Zone | Lumens | % lamp | % fixt |
|---|---|---|---|
| 0-30 | 1558 | 35.4 | 36.4 |
| 0-40 | 2209 | 50.2 | 51.6 |
| 0-60 | 3272 | 74.4 | 76.4 |
| 0-90 | 4283 | 97.3 | 100 |
| 90-120 | 0 | 0 | 0 |
| 90-130 | 0 | 0 | 0 |
| 90-150 | 0 | 0 | 0 |
| 90-180 | 0 | 0 | 0 |
| 0-180 | 4283 | 97.3 | 100 |

TABLE 16
Zonal Cavity Method

| | RC | | | | | | | | | | | | | | | | | |
|---|---|---|---|---|---|---|---|---|---|---|---|---|---|---|---|---|---|---|
| | 80 | | | | 70 | | | | 50 | | | 30 | | | 10 | | | 0 |
| RW | 70 | 50 | 30 | 10 | 70 | 50 | 30 | 10 | 50 | 30 | 10 | 50 | 30 | 10 | 50 | 30 | 10 | 0 |
| 0 | 116 | 116 | 116 | 116 | 113 | 113 | 113 | 113 | 108 | 108 | 108 | 104 | 104 | 104 | 99 | 99 | 99 | 97 |
| 1 | 106 | 102 | 97 | 94 | 103 | 99 | 96 | 92 | 95 | 92 | 89 | 91 | 89 | 87 | 88 | 86 | 84 | 82 |
| 2 | 97 | 89 | 83 | 78 | 95 | 88 | 82 | 77 | 84 | 79 | 75 | 81 | 77 | 73 | 78 | 75 | 72 | 70 |
| 3 | 90 | 80 | 73 | 67 | 87 | 78 | 72 | 66 | 76 | 70 | 65 | 73 | 68 | 64 | 71 | 66 | 63 | 61 |
| 4 | 83 | 72 | 64 | 58 | 81 | 71 | 63 | 57 | 68 | 62 | 57 | 66 | 60 | 56 | 64 | 59 | 55 | 53 |
| 5 | 76 | 65 | 56 | 50 | 74 | 64 | 56 | 50 | 62 | 55 | 49 | 60 | 54 | 49 | 58 | 53 | 48 | 46 |
| 6 | 71 | 59 | 51 | 45 | 69 | 58 | 50 | 45 | 56 | 49 | 44 | 55 | 49 | 44 | 53 | 48 | 43 | 42 |
| 7 | 66 | 54 | 46 | 40 | 65 | 53 | 45 | 40 | 52 | 45 | 40 | 50 | 44 | 39 | 49 | 43 | 39 | 37 |
| 8 | 62 | 49 | 41 | 36 | 60 | 48 | 41 | 36 | 47 | 40 | 35 | 46 | 40 | 35 | 45 | 39 | 35 | 33 |
| 9 | 57 | 45 | 37 | 32 | 56 | 44 | 37 | 32 | 43 | 36 | 32 | 42 | 36 | 31 | 41 | 35 | 31 | 30 |
| 10 | 54 | 41 | 34 | 29 | 53 | 41 | 34 | 29 | 40 | 33 | 29 | 39 | 33 | 29 | 38 | 32 | 28 | 27 |

FIG. 22a is a zonal lumination plot for the exemplary reflector of FIG. 17 using a single 54 watt T5 linear fluorescent lamp rated at 4400 lumens.

FIG. 22b is a zonal rumination plot for the exemplary reflector of FIG. 17 using two 54 watt T5 linear fluorescent lamps spaced 1.062 inches from the top of the reflector 170, each rated at 4400 lumens.

FIG. 22c is a zonal lumination plot for the exemplary reflector of FIG. 17 using two 54 watt T5 linear fluorescent lamps spaced 0.875 inches from the top of the reflector 170, each rated at 4400 lumens.

FIG. 23 is an isometric view of a reflector 230 for a luminaire according to another exemplary embodiment the invention. In an exemplary embodiment, the reflector 230 may use a single fluorescent lamp, such as a T8 lamp, to provide a more focused beam of light from a higher luminaire installation using lower wattage lamps. As illustrated in FIG. 23, the reflector 230 of this embodiment is similar to the reflector of the embodiment described in FIGS. 17-21. In this embodiment, however, the reflector is designed to house a T8 style fluorescent lamp.

The reflector 230 has sides 232 and socket notches 234. The socket notches 234 are similarly configured to the socket notches of the embodiment described in FIG. 1, and are operative to allow for the installation of electrical sockets for the fluorescent lamp portion within the reflector 230. The sides 232 extend generally downward in a parabolic manner from a top portion 238. The reflector 230 also has two fastener holes 236 in the top portion 238 that are used to attach the reflector 230 to a luminaire housing (not shown).

FIG. 24 is an illustration of a cross-sectional view of the exemplary reflector 230 of FIG. 23. As shown in FIG. 24, the reflector 230 has a rim 240 and sides 232 that are substantially similar to the corresponding features described above with respect to FIGS. 17-21. Each side 232 extends downward from the top portion 238. The top portion has a width 238a. In an exemplary embodiment, the top portion is 238 can be 0.676 inches wide. In this embodiment, the sides 232 terminate at the rim 240 a vertical distance 240a from the top of the reflector 230 and form an opening 246 having a width 2460a. In an exemplary embodiment, the sides 232 can terminate approximately 3.706 inches below the top of the reflector 230 and form an opening 246 that can be 8.204 inches wide. The rim 240 extends at an angle 242 that, in an exemplary embodiment, is approximately ninety degrees from the terminus of the sides 112. The rim 240 has a length 240b, which in an exemplary embodiment can be 0.404 inches long. The rims 240 terminate a distance 240c apart, which in an exemplary embodiment can be 8.972 inches.

As shown in FIG. 24, each side of this embodiment comprises five steps. The steps may take any number of forms as previously described above with respect to FIGS. 3-4. The dimensions of each step are listed below in Table 17.

TABLE 17

| Step | Distance along side (244a) | Angle from prior step (244b) |
|---|---|---|
| 1 | 0.779 in | 197.5° |
| 2 | 0.915 in | 195.5° |
| 3 | 0.283 in | 191.6° |
| 4 | 1.221 in | 188.2° |
| 5 | 1.392 in | 185.9° |

Table 18 below provides light distribution data for a configuration of the reflector 230 in a luminaire using a single 32 watt T8 fluorescent lamp rated at 2850 lumens. Table 19 below provides zonal lumen data for this configuration of the reflector 230, and Table 20 below provides the reflector's 230 efficiency of producing light on a horizontal surface as determined by the zonal cavity method.

TABLE 18
Candela distribution

| | 0 | 22.5 | 45 | 67.5 | 90 | Flux |
|---|---|---|---|---|---|---|
| 0 | 3174 | 3174 | 3174 | 3174 | 3174 | |
| 5 | 3139 | 3197 | 3265 | 3281 | 3300 | 309 |
| 15 | 3017 | 3197 | 2954 | 2394 | 2182 | 774 |
| 25 | 2795 | 2765 | 1572 | 1212 | 1108 | 864 |
| 35 | 2449 | 1731 | 922 | 671 | 614 | 761 |
| 45 | 2027 | 986 | 514 | 474 | 495 | 628 |
| 55 | 1529 | 512 | 392 | 438 | 400 | 505 |
| 65 | 984 | 242 | 208 | 0 | 0 | 237 |
| 75 | 470 | 133 | 0 | 0 | 0 | 93 |
| 85 | 51 | 4 | 0 | 0 | 0 | 12 |
| 90 | 4 | 7 | 0 | 0 | 0 | 0 |
| 95 | 1 | 4 | 0 | 0 | 0 | 1 |

TABLE 19
Zonal Lumen Summary

| Zone | Lumens | % lamp | % fixt |
|---|---|---|---|
| 0-30 | 1948 | 44.3 | 46.5 |
| 0-40 | 2708 | 61.6 | 64.7 |
| 0-60 | 3841 | 87.3 | 91.8 |
| 0-90 | 4183 | 95.1 | 99.9 |
| 90-120 | 2 | 0.1 | 0.1 |
| 90-130 | 2 | 0.1 | 0.1 |
| 90-150 | 2 | 0.1 | 0.1 |
| 90-180 | 2 | 0.1 | 0.1 |
| 0-180 | 4186 | 95.1 | 100 |

TABLE 20
Zonal Cavity Method

| | RC | | | | | | | | | | | | | | | | | |
|---|---|---|---|---|---|---|---|---|---|---|---|---|---|---|---|---|---|---|
| | 80 | | | | 70 | | | | 50 | | | 30 | | | 10 | | | 0 |
| RW | 70 | 50 | 30 | 10 | 70 | 50 | 30 | 10 | 50 | 30 | 10 | 50 | 30 | 10 | 50 | 30 | 10 | 0 |
| 0 | 113 | 113 | 113 | 113 | 111 | 111 | 111 | 111 | 106 | 106 | 106 | 101 | 101 | 101 | 97 | 97 | 97 | 95 |
| 1 | 107 | 103 | 100 | 98 | 104 | 101 | 99 | 96 | 97 | 95 | 93 | 94 | 92 | 90 | 90 | 89 | 88 | 86 |
| 2 | 100 | 94 | 89 | 85 | 97 | 92 | 88 | 84 | 89 | 85 | 82 | 86 | 83 | 80 | 83 | 81 | 79 | 77 |
| 3 | 93 | 86 | 80 | 75 | 91 | 84 | 79 | 75 | 82 | 77 | 73 | 79 | 75 | 72 | 77 | 74 | 71 | 69 |
| 4 | 87 | 78 | 72 | 67 | 85 | 77 | 71 | 66 | 75 | 70 | 65 | 73 | 68 | 65 | 71 | 67 | 64 | 62 |
| 5 | 81 | 71 | 64 | 59 | 79 | 70 | 64 | 59 | 68 | 63 | 58 | 67 | 62 | 58 | 65 | 61 | 57 | 55 |
| 6 | 76 | 65 | 58 | 53 | 74 | 64 | 58 | 53 | 63 | 57 | 53 | 61 | 56 | 52 | 60 | 55 | 52 | 50 |
| 7 | 71 | 60 | 53 | 48 | 69 | 59 | 53 | 48 | 58 | 52 | 48 | 57 | 51 | 47 | 55 | 51 | 47 | 45 |
| 8 | 66 | 55 | 48 | 43 | 65 | 54 | 48 | 43 | 53 | 47 | 43 | 52 | 47 | 43 | 51 | 46 | 42 | 41 |
| 9 | 61 | 50 | 43 | 39 | 60 | 50 | 43 | 39 | 49 | 43 | 38 | 48 | 42 | 38 | 47 | 72 | 38 | 37 |
| 10 | 58 | 46 | 43 | 35 | 56 | 46 | 39 | 35 | 45 | 39 | 35 | 44 | 39 | 35 | 43 | 38 | 35 | 33 |

FIG. 25a is a zonal lumination plot for the exemplary reflector of FIG. 23 using a single 32 watt T8 linear fluorescent lamp rated at 2850 lumens.

FIG. 25b is a zonal lamination plot for the exemplary reflector of FIG. 23 using two 32 watt T8 fluorescent lamps.

FIG. 26 is an illustration of a top view of a reflector 260 for a luminaire according to another exemplary embodiment of the present invention. As illustrated in FIG. 26, the reflector 260 has sides 262, socket notches 264, half-circle notches 266, and fastener holes 268 that are substantially similar to those of the embodiment described above with respect to FIGS. 1-4. The reflector itself has a length 260a. In an exemplary embodiment, the reflector 260 can be 48 inches long.

The socket notches 264 are located at either end of the reflector 260, and are an appropriate length 264a and width 264b to accommodate the installation of a standard socket. In an exemplary embodiment, the socket notches 264 can be 1.5 inches wide and 1.6 inches long, although the socket notches 264 may be of any size or shape necessary to accommodate a socket for a fluorescent lamp.

The half-circle notches 266 are located in pairs at each end of the reflector 260 and are configured to allow a power cable (not shown) to pass through the reflector 260 to a luminaire housing (not shown) in an embodiment wherein multiple reflectors 266 are connected to one another along their ends. The half-circle notches 266 may be of any diameter and in any distance from the center of the reflector 260 that is appropriate to fasten the reflector 260 to a luminaire housing (not shown).

The fastener holes 268 are located along the axial center of the reflector 260 and are positioned in order to facilitate the connection of the reflector 260 to the luminaire housing (not shown). The fastener holes are located a distance 268a on either side of the center of the reflector 260. In this embodiment, the fastener holes 268 can be approximately 21.78 inches from the center of the reflector 260. However, the distance 268a between the fastener holes 268 and the center of the reflector 260 varies depending on the size of the fluorescent lamp to be used in the light fixture. Depending on the size of fluorescent lamp and type of luminaire housing used, the fastener holes 268 may be of any appropriate size and placed in any appropriate location to facilitate the connection of the reflector 260 to the luminaire housing (not shown).

The reflector 260 also has secondary fastener holes 270 that may assist in coupling the reflector to the luminaire housing (not shown). The secondary fastener holes 270 have a diameter 270a and are disposed a distance 270b from the center of the reflector 260. In an exemplary embodiment, the secondary fastener holes 270 may be disposed 20.26 inches from the center of the reflector 260, and may be 0.19 inches in diameter, although the dimensions and locations of the secondary fastener holes can be of any size appropriate to fasten the reflector to a luminaire housing.

FIG. 27 is an illustration of a cross-sectional view of the exemplary reflector 230 of FIG. 26. As shown in FIG. 27, the reflector 260 has a rim 276 and sides 262 that are substantially similar to the corresponding features described above with respect to FIG. 24. Each side 262 extends downward from the top portion 272. The top portion has a width 272a. In an exemplary embodiment, the top portion 272 can be 0.688 inches wide. In this embodiment, the sides 2262 terminate at the rim 276 and form an opening 278. The rim 276 extends at an angle 278 that, in an exemplary embodiment, is approximately ninety degrees from the terminus of the sides 262. The rims 276 have a length 276a, which in an exemplary embodiment can be 0.375 inches long.

As shown in FIG. 27, each side of this embodiment comprises five steps. The steps may take any number of forms as previously described above with respect to FIGS. 3-4. The dimensions of each step are listed below in Table 21.

TABLE 21

| Step | Distance Along Side (274) | Angle from Prior Step (274a) |
|---|---|---|
| 1 | 0.79 | 160.45° |
| 2 | 0.924 | 158.48° |
| 3 | 1.073 | 165.41° |
| 4 | 1.102 | 170.84° |
| 5 | 1.167 | 174.09° |

Table 21a below provides light distribution data for a configuration of the reflector 260 in a luminaire using a single 54 watt T5 fluorescent lamp rated at 4460 lumens. Table 21b below provides zonal lumen data for this configuration of the reflector 260, and Table 21c below provides the reflector's 260 efficiency of producing light on a horizontal surface as determined by the zonal cavity method.

TABLE 21a
Candela distribution

| | 0 | 22.5 | 45 | 67.5 | 90 |
|---|---|---|---|---|---|
| 0 | 2889 | 2889 | 2889 | 2889 | 2889 |
| 2.5 | 2889 | 2890 | 2902 | 2917 | 2909 |
| 5 | 2881 | 2900 | 2968 | 3043 | 3061 |
| 7.5 | 2866 | 2924 | 3097 | 3211 | 3221 |
| 10 | 2846 | 2969 | 3196 | 3264 | 3260 |
| 12.5 | 2815 | 3020 | 3223 | 3209 | 3122 |
| 15 | 2782 | 3058 | 3198 | 2901 | 2715 |
| 17.5 | 2740 | 3073 | 3028 | 2467 | 2278 |
| 20 | 2691 | 3055 | 2709 | 2071 | 1890 |
| 22.5 | 2637 | 3017 | 2342 | 1734 | 1591 |
| 25 | 2578 | 2957 | 2010 | 1472 | 1342 |
| 27.5 | 2511 | 2852 | 1718 | 1231 | 1095 |
| 30 | 2441 | 2674 | 1473 | 1012 | 897 |
| 32.5 | 2366 | 2432 | 1267 | 823 | 724 |
| 35 | 2285 | 2160 | 1058 | 676 | 627 |
| 37.5 | 2199 | 1898 | 885 | 585 | 564 |
| 40 | 2109 | 1655 | 725 | 533 | 535 |
| 42.5 | 2012 | 1427 | 597 | 502 | 479 |
| 45 | 1912 | 1223 | 514 | 446 | 386 |
| 47.5 | 1807 | 1047 | 458 | 351 | 246 |
| 50 | 1699 | 886 | 427 | 215 | 107 |
| 52.5 | 1588 | 721 | 371 | 88 | 30 |
| 55 | 1476 | 584 | 286 | 22 | 0 |
| 57.5 | 1361 | 454 | 163 | 0 | 0 |
| 60 | 1243 | 357 | 59 | 0 | 0 |
| 62.5 | 1124 | 287 | 8 | 0 | 0 |
| 65 | 1004 | 250 | 0 | 0 | 0 |
| 67.5 | 884 | 208 | 1 | 0 | 0 |
| 70 | 762 | 141 | 0 | 0 | 0 |
| 72.5 | 643 | 56 | 0 | 0 | 0 |
| 75 | 525 | 18 | 0 | 0 | 0 |
| 77.5 | 409 | 13 | 0 | 0 | 0 |
| 80 | 298 | 10 | 0 | 0 | 0 |
| 82.5 | 195 | 9 | 0 | 0 | 0 |
| 85 | 100 | 6 | 0 | 0 | 0 |
| 87.5 | 29 | 5 | 1 | 1 | 0 |
| 90 | 0 | 0 | 0 | 0 | 0 |

TABLE 21b
Zonal Lumen Summary

| Zone | Lumens | Summary |
|---|---|---|
| 0- | 5 | 69 |
| 5- | 10 | 220 |
| 10- | 15 | 368 |
| 15- | 20 | 456 |
| 20- | 25 | 483 |
| 25- | 30 | 481 |
| 30- | 35 | 447 |
| 35- | 40 | 396 |
| 40- | 45 | 349 |
| 45- | 50 | 291 |
| 50- | 55 | 216 |
| 55- | 60 | 150 |
| 60- | 65 | 104 |
| 65- | 70 | 82 |
| 70- | 75 | 49 |
| 75- | 80 | 29 |
| 80- | 85 | 14 |
| 85- | 90 | 3 |

TABLE 21c

| | RC | | | | | | | | | | | | | | | | | |
|---|---|---|---|---|---|---|---|---|---|---|---|---|---|---|---|---|---|---|
| | 80 | | | | 70 | | | | 50 | | | 30 | | | 10 | | | 0 |
| RW | 70 | 50 | 30 | 10 | 70 | 50 | 30 | 10 | 50 | 30 | 10 | 50 | 30 | 10 | 50 | 30 | 10 | 0 |
| 0 | 112 | 112 | 112 | 112 | 110 | 110 | 110 | 110 | 105 | 105 | 105 | 100 | 100 | 100 | 96 | 96 | 96 | 94 |
| 1 | 105 | 102 | 99 | 96 | 103 | 100 | 97 | 95 | 96 | 94 | 92 | 93 | 91 | 89 | 89 | 88 | 87 | 85 |
| 2 | 98 | 93 | 88 | 84 | 96 | 91 | 86 | 83 | 88 | 84 | 81 | 85 | 80 | 77 | 76 | 81 | 79 | 77 |
| 3 | 92 | 84 | 78 | 74 | 90 | 83 | 77 | 73 | 80 | 76 | 72 | 78 | 74 | 71 | 76 | 72 | 69 | 68 |
| 4 | 86 | 77 | 70 | 65 | 84 | 76 | 70 | 65 | 74 | 68 | 64 | 72 | 67 | 63 | 70 | 66 | 63 | 61 |
| 5 | 80 | 71 | 64 | 59 | 79 | 70 | 63 | 58 | 68 | 62 | 58 | 66 | 61 | 57 | 64 | 60 | 57 | 55 |
| 6 | 75 | 65 | 58 | 53 | 74 | 64 | 58 | 53 | 63 | 57 | 53 | 61 | 56 | 52 | 60 | 55 | 52 | 50 |
| 7 | 71 | 60 | 53 | 48 | 69 | 59 | 53 | 48 | 58 | 52 | 48 | 57 | 52 | 48 | 56 | 51 | 47 | 46 |
| 8 | 67 | 56 | 49 | 45 | 65 | 55 | 49 | 44 | 54 | 48 | 44 | 53 | 48 | 44 | 52 | 47 | 44 | 42 |
| 9 | 63 | 52 | 46 | 41 | 62 | 52 | 45 | 41 | 51 | 45 | 41 | 50 | 44 | 41 | 49 | 44 | 40 | 39 |
| 10 | 59 | 49 | 42 | 38 | 58 | 48 | 42 | 38 | 47 | 42 | 38 | 47 | 41 | 38 | 46 | 41 | 38 | 36 |

FIG. 28 is a zonal rumination chart for the exemplary reflector of FIG. 26 using a single 54 watt T5 linear fluorescent lamp rated at 4460 lumens.

FIG. 29 is an illustration of a top view of a reflector 290 for a luminaire according to another exemplary embodiment of the present invention. As illustrated in FIG. 29, the reflector 290 has sides 292, socket notches 294, half-circle notches 296, and fastener holes 298 that are substantially similar to those of the embodiment described above with respect to FIGS. 1-4. The reflector itself has a length 290a. In an exemplary embodiment, the reflector 290 can be 48 inches long.

The socket notches 294 are located at either end of the reflector 290, and are an appropriate length 294a and width 294b to accommodate the installation of a standard socket. In an exemplary embodiment, the socket notches 294 can be 2.963 inches long and 0.775 inches wide, although the socket notches 294 may be of any size or shape necessary to accommodate a socket for a fluorescent lamp.

The half-circle notches 296 are located in pairs at each end of the reflector 290 and are configured to allow a power cable (not shown) to pass through the reflector 290 to a luminaire housing (not shown) in an embodiment wherein multiple reflectors 290 are connected to one another along their ends. The half-circle notches 296 may be of any diameter and in any distance from the center of the reflector 290 that is appropriate to fasten the reflector 290 to a luminaire housing (not shown). The half-circle notches 296 are spaced a distance 296a apart, which, in an exemplary embodiment, may be 5.203 inches.

The fastener holes 298 are located along the axial center of the reflector 290 and are positioned in order to facilitate the connection of the reflector 290 to the luminaire housing (not shown). The fastener holes are located a distance 298a from the end of the reflector 290. In this embodiment, the fastener holes 298 can be approximately 1.140 inches from the end of the reflector 290. However, the distance 298a between the fastener holes 298 and the end of the reflector 290 varies depending on the size of the fluorescent lamp to be used in the light fixture. Depending on the size of fluorescent lamp and type of luminaire housing used, the fastener holes 268 may be of any appropriate size and placed in any appropriate location to facilitate the connection of the reflector 290 to the luminaire housing (not shown).

FIG. 30 is an illustration of a cross-sectional view of the reflector of FIG. 29. As shown in FIG. 30, the reflector 290 has a rim 304 and sides 292 that are substantially similar to the corresponding features described above with respect to FIG. 24. Each side 292 extends downward from the top portion 300. The top portion has a width 300a. In an exemplary embodiment, the top portion 300 can be between 0.688 inches and 0.790 inches wide. In this embodiment, the sides 292 terminate at the rim 304 and form an opening. The rim 304 extends at an angle 306 that, in an exemplary embodiment, is approximately 58.69 degrees from the terminus of the sides 292. The rims 304 have a length 304a, which in an exemplary embodiment can be 0.471 inches long.

As shown in FIG. 30, each side of this embodiment comprises five steps. The steps may take any number of forms as previously described above with respect to FIGS. 3-4. The dimensions of each step are listed below in Table 22. The dimensions of each step of an alternative exemplary embodiment of the reflector of FIG. 29 are listed below in Table 23.

TABLE 22

| Step | Distance Along Side (302a) | Angle from Prior Step (302b) |
|---|---|---|
| 1 | 0.79 | 162.48° |
| 2 | 0.924 | 164.48° |
| 3 | 1.073 | 165.41° |
| 4 | 1.226 | 170.84° |
| 5 | 1.273 | 172.09° |

TABLE 23

| Step | Distance Along Side (302a) | Angle from Prior Step (302b) |
|---|---|---|
| 1 | 0.79 | 160.48° |
| 2 | 0.924 | 162.48° |
| 3 | 1.073 | 165.41° |
| 4 | 1.102 | 170.84° |
| 5 | 1.167 | 172.09° |

FIG. 31 is an illustration of a top view of a reflector 310 for a luminaire according to another exemplary embodiment of the present invention. As illustrated in FIG. 31, the reflector 310 has sides 312, socket notches 314, half-circle notches 316, and fastener holes 318 that are substantially similar to those of the embodiment described above with respect to FIG. 26.

The socket notches 314 are located at either end of the reflector 310, and are an appropriate length 314a and width 314b to accommodate the installation of a standard socket. In an exemplary embodiment, the socket notches 314 can be 1.5 inches wide and 1.6 inches long, although the socket notches 314 may be of any size or shape necessary to accommodate a socket for a fluorescent lamp.

The half-circle notches 316 are located in pairs at each end of the reflector 260 and are configured to allow a power cable (not shown) to pass through the reflector 310 to a luminaire housing (not shown) in an embodiment wherein multiple reflectors 310 are connected to one another along their ends. The half-circle notches 316 may be of any diameter and in a distance 316a from the center of the reflector 310 that is appropriate to fasten the reflector 310 to a luminaire housing (not shown). In an exemplary embodiment, the half circle notches may be 2.12 inches from the center of the reflector 310.

The fastener holes 318 are located along the axial center of the reflector 310 and are positioned in order to facilitate the connection of the reflector 310 to the luminaire housing (not shown). The fastener holes are located a distance 318a on either side of the center of the reflector 310. In this embodiment, the fastener holes 318 can be approximately 21.80 inches from the center of the reflector 310. However, the distance 318a between the fastener holes 318 and the center of the reflector 310 varies depending on the size of the fluorescent lamp to be used in the light fixture. Depending on the size of fluorescent lamp and type of luminaire housing used, the fastener holes 318 may be of any appropriate size and placed in any appropriate location to facilitate the connection of the reflector 310 to the luminaire housing (not shown).

The reflector 310 also has secondary fastener holes 320 that may assist in coupling the reflector to the luminaire housing (not shown). The secondary fastener holes 320 have a diameter 320a and are disposed a distance 320b from the center of the reflector 310. In an exemplary embodiment, the secondary fastener holes 320 may be disposed 20.25 inches from the center of the reflector 320, and may be 0.19 inches in diameter, although the dimensions and locations of the secondary fastener holes can be of any size appropriate to fasten the reflector to a luminaire housing.

FIG. 32 is an illustration of a cross-sectional view of the reflector of FIG. 31. As shown in FIG. 32, the reflector 310 has a rim 326 and sides 312 that are substantially similar to the corresponding features described above with respect to FIG. 24. Each side 312 extends downward from the top portion 322. In this embodiment, the sides 312 terminate at the rim 326 and form an opening. The rim 326 extends at an angle 328 that, in an exemplary embodiment, is approximately 58.69 degrees from the terminus of the sides 312. The rims 326 have a length 326a, which in an exemplary embodiment can be 0.471 inches long.

As shown in FIG. 32, each side of this embodiment comprises five steps. The steps may take any number of forms as previously described above with respect to FIGS. 3-4. The dimensions of each step are listed below in Table 24.

TABLE 24

| Step | Distance Along Side (324a) | Angle from Prior Step (324b) |
|---|---|---|
| 1 | 0.79 | 160.48° |
| 2 | 0.924 | 162.48° |
| 3 | 1.073 | 165.41° |
| 4 | 1.102 | 170.84° |
| 5 | 1.167 | 172.09° |

Table 24a below provides light distribution data for a configuration of the reflector 310 in a luminaire using a single 54 watt T5 fluorescent lamp rated at 4460 lumens. Table 24b below provides zonal lumen data for this configuration of the reflector 410, and Table 24c below provides the reflector's 310 efficiency of producing light on a horizontal surface as determined by the zonal cavity method.

TABLE 24a
Candela distribution

| | 0 | 22.5 | 45 | 67.5 | 90 |
|---|---|---|---|---|---|
| 0 | 3848 | 3848 | 3848 | 3848 | 3848 |
| 2.5 | 3837 | 3856 | 3884 | 3911 | 3907 |
| 5 | 3830 | 3885 | 3935 | 3898 | 3850 |
| 7.5 | 3802 | 3906 | 3788 | 3615 | 3520 |
| 10 | 3777 | 3878 | 3548 | 3174 | 3026 |
| 12.5 | 3738 | 3760 | 3188 | 2693 | 2531 |
| 15 | 3691 | 3606 | 2791 | 2260 | 2072 |
| 17.5 | 3636 | 3433 | 2436 | 1807 | 1630 |
| 20 | 3574 | 3203 | 2076 | 1481 | 1359 |
| 22.5 | 3502 | 2946 | 1708 | 1232 | 1101 |
| 25 | 3423 | 2669 | 1439 | 1009 | 945 |
| 27.5 | 3336 | 2405 | 1228 | 886 | 845 |
| 30 | 3241 | 2154 | 1022 | 795 | 754 |
| 32.5 | 3138 | 1901 | 875 | 708 | 665 |
| 35 | 3031 | 1640 | 782 | 625 | 598 |
| 37.5 | 2917 | 1384 | 701 | 564 | 561 |
| 40 | 2795 | 1190 | 623 | 531 | 536 |
| 42.5 | 2668 | 1030 | 547 | 505 | 509 |
| 45 | 2536 | 871 | 488 | 479 | 504 |
| 47.5 | 2398 | 717 | 452 | 474 | 454 |
| 50 | 2255 | 609 | 424 | 419 | 334 |
| 52.5 | 2105 | 529 | 396 | 292 | 167 |
| 55 | 1953 | 457 | 386 | 135 | 45 |
| 57.5 | 1797 | 388 | 331 | 28 | 0 |
| 60 | 1640 | 323 | 210 | 0 | 0 |
| 62.5 | 1478 | 277 | 75 | 1 | 0 |
| 65 | 1316 | 246 | 5 | 0 | 0 |
| 67.5 | 1153 | 218 | 2 | 0 | 0 |
| 70 | 992 | 201 | 1 | 0 | 0 |
| 72.5 | 830 | 130 | 1 | 0 | 0 |
| 75 | 674 | 37 | 0 | 0 | 0 |
| 77.5 | 520 | 17 | 0 | 0 | 0 |
| 80 | 373 | 13 | 0 | 0 | 0 |
| 82.5 | 230 | 10 | 0 | 0 | 0 |
| 85 | 106 | 8 | 0 | 0 | 0 |
| 87.5 | 24 | 5 | 0 | 0 | 0 |
| 90 | 0 | 0 | 0 | 0 | 0 |

TABLE 24b
Zonal Lumen Summary

| Zone | Lumens | Summary |
|---|---|---|
| 0- | 5 | 93 |
| 5- | 10 | 268 |
| 10- | 15 | 379 |
| 15- | 20 | 425 |
| 20- | 25 | 429 |
| 25- | 30 | 418 |
| 30- | 35 | 397 |
| 35- | 40 | 366 |
| 40- | 45 | 340 |
| 45- | 50 | 310 |
| 50- | 55 | 256 |
| 55- | 60 | 190 |
| 60- | 65 | 133 |
| 65- | 70 | 101 |
| 70- | 75 | 71 |
| 75- | 80 | 37 |
| 80- | 85 | 17 |
| 85- | 90 | 2 |

TABLE 24c

| | RC | | | | | | | | | | | | | | | | | |
|---|---|---|---|---|---|---|---|---|---|---|---|---|---|---|---|---|---|---|
| | 80 | | | | 70 | | | | 50 | | | 30 | | | 10 | | | 0 |
| RW | 70 | 50 | 30 | 10 | 70 | 50 | 30 | 10 | 50 | 30 | 10 | 50 | 30 | 10 | 50 | 30 | 10 | 0 |
| 0 | 113 | 113 | 113 | 113 | 110 | 110 | 110 | 110 | 105 | 105 | 105 | 101 | 101 | 101 | 97 | 97 | 97 | 95 |
| 1 | 106 | 102 | 99 | 96 | 103 | 100 | 97 | 95 | 96 | 94 | 92 | 93 | 91 | 89 | 89 | 88 | 87 | 85 |
| 2 | 99 | 92 | 87 | 83 | 96 | 91 | 86 | 82 | 87 | 84 | 80 | 85 | 81 | 79 | 82 | 79 | 77 | 75 |
| 3 | 92 | 84 | 78 | 73 | 90 | 82 | 77 | 72 | 80 | 75 | 71 | 77 | 73 | 70 | 75 | 72 | 69 | 67 |
| 4 | 86 | 76 | 70 | 64 | 84 | 75 | 69 | 64 | 73 | 68 | 63 | 71 | 66 | 62 | 69 | 65 | 62 | 60 |
| 5 | 80 | 70 | 63 | 58 | 78 | 69 | 62 | 58 | 67 | 61 | 57 | 65 | 60 | 56 | 64 | 59 | 56 | 54 |
| 6 | 75 | 65 | 57 | 52 | 73 | 64 | 57 | 52 | 62 | 56 | 52 | 61 | 55 | 51 | 59 | 55 | 51 | 49 |
| 7 | 71 | 60 | 53 | 48 | 69 | 59 | 52 | 48 | 58 | 52 | 47 | 56 | 51 | 47 | 55 | 50 | 47 | 45 |
| 8 | 66 | 56 | 49 | 44 | 65 | 55 | 48 | 44 | 54 | 48 | 44 | 53 | 47 | 43 | 52 | 47 | 43 | 42 |
| 9 | 63 | 52 | 45 | 41 | 62 | 51 | 45 | 41 | 50 | 45 | 40 | 49 | 44 | 40 | 49 | 44 | 40 | 39 |
| 10 | 59 | 49 | 42 | 38 | 58 | 48 | 42 | 38 | 47 | 42 | 38 | 47 | 41 | 37 | 46 | 41 | 37 | 36 |

FIG. 33 is a zonal lumination chart for the exemplary reflector of FIG. 31 using a single 54 watt T5 linear fluorescent lamp rated at 4460 lumens.

FIG. 34 is an illustration of a top view of a reflector 340 for a luminaire according to another exemplary embodiment of the present invention. As illustrated in FIG. 34, the reflector 340 has sides 342, socket notches 344, half-circle notches 346, and fastener holes 348 that are substantially similar to those of the embodiment described above with respect to FIG. 29. The reflector itself has a length 340a. In an exemplary embodiment, the reflector 340 can be 48 inches long.

The socket notches 344 are located at either end of the reflector 340, and are an appropriate length 344a and width 344b to accommodate the installation of a standard socket. In an exemplary embodiment, the socket notches 344 can be 2.963 inches long and 0.775 inches wide, although the socket notches 344 may be of any size or shape necessary to accommodate a socket for a fluorescent lamp.

The half-circle notches 346 are located in pairs at each end of the reflector 340 and are configured to allow a power cable (not shown) to pass through the reflector 340 to a luminaire housing (not shown) in an embodiment wherein multiple reflectors 340 are connected to one another along their ends. The half-circle notches 346 may be of any diameter and in any distance from the center of the reflector 340 that is appropriate to fasten the reflector 340 to a luminaire housing (not shown). The half-circle notches 346 are spaced a distance 346a apart, which, in an exemplary embodiment, may be 5.203 inches.

The fastener holes 348 are located along the axial center of the reflector 340 and are positioned in order to facilitate the connection of the reflector 340 to the luminaire housing (not shown). The fastener holes are located a distance 348a from the end of the reflector 340. In this embodiment, the fastener holes 348 can be approximately 1.140 inches from the end of the reflector 340. However, the distance 348a between the fastener holes 348 and the end of the reflector 340 varies depending on the size of the fluorescent lamp to be used in the light fixture. Depending on the size of fluorescent lamp and type of luminaire housing used, the fastener holes 348 may be of any appropriate size and placed in any appropriate location to facilitate the connection of the reflector 340 to the luminaire housing (not shown).

FIG. 35 is an illustration of a cross-sectional view of the reflector of FIG. 34. As shown in FIG. 35, the reflector 340 has a rim 354 and sides 342 that are substantially similar to the corresponding features described above with respect to FIG. 32. Each side 342 extends downward from the top portion 350. The top portion has a width 350a. In an exemplary embodiment, the top portion 350 can be 0.896 inches wide. In this embodiment, the sides 342 terminate at the rim 354 and form an opening a distance 340c from the top portion 350. The rim 354 extends at an angle 354b that, in an exemplary embodiment, is slightly greater than ninety degrees from the terminus of the sides 342. The rims 354 have a length 354a, which in an exemplary embodiment can be 0.471 inches long. In an exemplary embodiment, the sides 342 may terminate 3.713 inches from the top portion 350.

As shown in FIG. 35, each side of this embodiment comprises seven steps. The steps may take any number of forms as previously described above with respect to FIGS. 3-4. The dimensions of each step are listed below in Table 25.

TABLE 25

| Step | Distance Along Side (352a) | Angle from Horizontal (352b) |
|---|---|---|
| 1 | 0.896 | 167.82° |
| 2 | 0.6 | 154.83° |
| 3 | 0.65 | 142.49° |
| 4 | 0.7 | 131.79° |
| 5 | 0.75 | 122.36° |
| 6 | 0.8 | 113.89° |
| 7 | 0.805 | 106.18° |

FIG. 36 is an illustration of a top view of a reflector 360 for a luminaire according to another exemplary embodiment of the present invention. As illustrated in FIG. 36, the reflector 360 has sides 362, socket notches 364, half-circle notches 366, and fastener holes 368 that are substantially similar to those of the embodiment described above with respect to FIG. 34. The reflector itself has a length 360a. In an exemplary embodiment, the reflector 360 can be 48 inches long.

The socket notches 364 are located at either end of the reflector 360, and are an appropriate length 364a and width 364b to accommodate the installation of a standard socket. In an exemplary embodiment, the socket notches 364 can be 2.963 inches long and 0.775 inches wide, although the socket notches 364 may be of any size or shape necessary to accommodate a socket for a fluorescent lamp.

The half-circle notches 366 are located in pairs at each end of the reflector 360 and are configured to allow a power cable (not shown) to pass through the reflector 360 to a luminaire housing (not shown) in an embodiment wherein multiple reflectors 360 are connected to one another along their ends. The half-circle notches 366 may be of any diameter and in any distance from the center of the reflector 360 that is appropriate to fasten the reflector 360 to a luminaire housing (not shown). The half-circle notches 366 are spaced a distance 366a apart, which, in an exemplary embodiment, may be 5.203 inches.

The fastener holes 368 are located along the axial center of the reflector 360 and are positioned in order to facilitate the connection of the reflector 360 to the luminaire housing (not shown). The fastener holes are located a distance 368a from the end of the reflector 360. In this embodiment, the fastener holes 368 can be approximately 1.140 inches from the end of the reflector 360. However, the distance 368a between the fastener holes 368 and the end of the reflector 360 varies depending on the size of the fluorescent lamp to be used in the light fixture. Depending on the size of fluorescent lamp and type of luminaire housing used, the fastener holes 368 may be of any appropriate size and placed in any appropriate location to facilitate the connection of the reflector 360 to the luminaire housing (not shown).

FIG. 37 is an illustration of a cross-sectional view of the reflector of FIG. 36. As shown in FIG. 37, the reflector 360 has a rim 374 and sides 362 that are substantially similar to the corresponding features described above with respect to FIG. 35. Each side 362 extends downward from the top portion 370. The top portion has a width 370a. In an exemplary embodiment, the top portion 370 can be 0.7 inches wide. In this embodiment, the sides 362 terminate at the rim 374 and form an opening a distance 360c from the top portion 370. The rim 374 extends at an angle 374b that, in an exemplary embodiment, is slightly greater than ninety degrees from the terminus of the sides 362. The rims 374 have a length 374a, which in an exemplary embodiment can be 0.471 inches long. In an exemplary embodiment, the sides 362 terminate a distance 3.713 inches from the top portion 370.

As shown in FIG. 37, each side of this embodiment comprises seven steps. The steps may take any number of forms as previously described above with respect to FIGS. 3-4. The dimensions of each step are listed below in Table 26.

TABLE 26

| Step | Distance Along Side (372a) | Angle from Horizontal (372b) |
|---|---|---|
| 1 | 0.896 | 163.12° |
| 2 | 0.6 | 144.44° |
| 3 | 0.65 | 128.68° |
| 4 | 0.7 | 115.67° |
| 5 | 0.75 | 104.80° |
| 6 | 0.8 | 95.89° |

It will be apparent to a person having ordinary skill in the at that the above-described reflectors are exemplary embodiments of the reflector of the present invention and are not intended to be limiting. For example, similar reflectors of differing sizes that will accommodate a variety of luminaire lamps and housings are contemplated by the present invention. Further, a reflector in accordance with the present invention can be made of any suitable material and can have any appropriate reflective surface.

It is understood that the foregoing description describes examples only and the claims are intended to cover deviations from this disclosure.

Any spatial references such as, for example, “upper,” “lower,” “above,” “below,” “between,” “vertical,” “horizontal,” “angular,” “upward,” “downward,” “side-to-side,” “left-to-right,” “right-to-left,” “top-to-bottom,” “bottom-to-top,” “left,” “right,” etc., are for the purpose of illustration only and do not limit the specific orientation or location of the structure described above.

In several exemplary embodiments, one or more of the operational steps in each embodiment may be omitted. Additionally, in some instances, some features of the present disclosure may be employed without a corresponding use of the other features. Furthermore, one or more of the above-described embodiments and/or variations may be combined in whole or in part with any one or more of the other above-described embodiments and/or variations.

Although several exemplary embodiments have been described in detail above, the embodiments described are exemplary only and are not limiting, and those having ordinary skill in the art will readily appreciate that many other modifications, changes, and/or substitutions are possible in the exemplary embodiments without materially departing from the novel teachings and advantages of the present disclosure. Accordingly, all such modifications, changes, and/or substitutions are intended to be included within the scope of this disclosure as defined in the following claims.

1-35. (canceled)

36. A reflector for a luminaire operative to reflect light provided by a lamp, the reflector comprising:
a first side operative to reflect light; and
a second side operative to reflect light and coupled to the first side,
wherein the first side and the second side each comprise a plurality of steps.

37. The reflector of claim 36, wherein the first side and the second side form a substantially parabolic shape.

38. The reflector of claim 36, wherein the second side is coupled to the first side via a flat portion configured to couple the reflector to a luminaire housing.

39. The reflector of claim 38, wherein each plurality of steps comprises a first step and a second step,
wherein the second step comprises a plurality of steps.

40. The reflector of claim 39, wherein the second step comprises four steps.

41. The reflector of claim 40, wherein the first step is coupled to the flat portion, and the second step is coupled to the first step.

42. The reflector of claim 41, wherein the first step forms a first angle where the first step couples to the flat portion, and the second step forms a second angle where the second step couples to the first step.

43. The reflector of claim 42, wherein each of the second steps forms an angle where each step is coupled to another step.

44. The reflector of claim 42, wherein the first angle is within the range of 158 to 162 degrees.

45. The reflector of claim 42, wherein the second angle is within the range of 156-160 degrees.

46. The reflector of claim 38, wherein the plurality of steps on the first side and the plurality of steps on the second side each comprise a first step that forms a first angle where the first step is coupled to the flat portion, a second step that forms a second angle where the second step is coupled to the first step, a third step that forms a third angle where the third step is coupled to the second step, a fourth step that forms a fourth angle where the fourth step is coupled to the third step, and a fifth step that forms a fifth angle where the fifth step is coupled to the fourth step.

47. The reflector of claim 46, wherein the first angle is within the range of 158 to 162 degrees.

48. The reflector of claim 46, wherein the second angle is within the range of 156 to 160 degrees.

49. The reflector of claim 46, wherein the third angle is within the range of 163 to 167 degrees.

50. The reflector of claim 46, wherein the fourth angle is within the range of 168 to 172 degrees.

51. The reflector of claim 46, wherein the fifth angle is within the range of 172 to 176 degrees.

52. A reflector for a luminaire operative to reflect light provided by a lamp, the reflector comprising:
a first side operative to reflect light;
a second side operative to reflect light; and
a flat portion operative to reflect light and coupled to the first side and the second side,
wherein the first side and the second side each comprise a plurality of steps.

53. The reflector of claim 52, wherein each of the plurality of steps of the first side and the second side comprise a first step coupled to the flat portion, a second step coupled to the first step, a third step coupled to the second step, a fourth step coupled to the third step, and a fifth step coupled to the fourth step,
wherein the first step forms an angle within the range of 158 top 162 degrees where the first step is coupled to the flat portion, the second step forms an angle within the range of 156 to 160 degrees where the second step is coupled to the first step, the third step forms an angle within the range of 163 to 167 degrees where the third step is coupled to the second step, the fourth step forms an angle within the range of 168 to 172 degrees where the fourth step is coupled to the third step, and the fifth step forms an angle within the range of 172 to 176 degrees where the fifth step is coupled to the fourth step.

54. The reflector of claim 53, wherein a rim is coupled to the fifth step, and wherein the rim is substantially orthogonal with respect to the fifth step.

55. A reflector for a luminaire operative to reflect light provided by a lamp, the reflector comprising:
a first side operative to reflect light;
a second side operative to reflect light and coupled to the first side, wherein the first side and the second side each comprise a first step, a second step, a third step, a fourth step, and a fifth step;
a flat portion coupled to the first step of the first side and the first step of the second side;
wherein the first step is about 0.8 inches long and forms an angle of about 160 degrees where the first step is coupled to the flat portion;
wherein the second step is about 0.9 inches long and forms an angle of about 158 degrees where the second step is coupled to the first step;
wherein the third step is about 1.07 inches long and forms an angle of about 165 degrees where the third step is coupled to the second step;
wherein the fourth step is about 1.1 inches long and forms an angle of about 170 degrees where the fourth step is coupled to the third step;
wherein the fifth step is about 1.167 inches long and forms an angle of about 174 degrees where the fifth step is coupled to the fourth step; and
wherein the fifth step is coupled to a rim, forming an angle of about 90 degrees with the fifth step, wherein the rim is about 0.375 inches long.
